(19) United States
(12) Patent Application Publication
(10) Pub. No.: US 2026/0290194 A1
(43) Pub. Date: Sep. 24, 2026

(54) SYSTEM

(71) Applicant: SoftBank Group Corp., Tokyo (JP)

(72) Inventor: Satoshi HIRATA, Tokyo (JP)

(73) Assignee: SoftBank Group Corp., Tokyo (JP)

(21) Appl. No.: 19/567,261

(22) Filed: Mar. 16, 2026

(30) Foreign Application Priority Data
Mar. 19, 2025 (JP) 2025-045272

(51) Int. Cl. G09B 7/04; G06F 40/205; G06F 40/40; G06N 3/0475

(52) U.S. Cl. CPC G09B 7/04; G06F 40/205; G06F 40/40; G06N 3/0475

(57) ABSTRACT

A system includes a processor that is configured to generate, using a generative artificial intelligence model, a learning story based on a curriculum of an educational institution, generate a prompt according to a learning progress of a learner and instruct, by using the prompt, automatic creation of a problem set, and recognize, in real time, an emotional state of the learner and generate a prompt that instructs dynamic adjustment of content of the learning story and of the problem set based on the emotional state of the learner.

### CROSS-REFERENCE TO RELATED APPLICATION

This application is based on and claims priority under 35 USC 119 from Japanese Patent Application No. 2025-045272 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted learning systems mainly provide static learning paths and fixed problem sets that are manually designed in advance. Such systems are not sufficiently capable of dynamically adapting learning content to individual learners in real time. In particular, these systems have the following problems. First, the learning story, namely the sequence and manner in which learning content is presented, is typically fixed according to a general curriculum and is not flexibly generated for each learner based on detailed curriculum data. Second, problem sets are usually prepared as predetermined collections of questions and are not automatically created on demand based on the learner's current progress or performance, thereby limiting the ability to provide appropriate practice at the right time. Third, conventional systems do not adequately take into account the learner's emotional state, such as frustration, confusion, or boredom, and therefore cannot dynamically adjust the difficulty level, amount, or style of content in response to such emotions. Fourth, although some systems allow learners to access definitions or glossaries, they do not automatically generate detailed, context-aware explanations of terms or concepts that are difficult for the learner to understand, using advanced natural language processing techniques. As a result, existing systems are limited in providing highly personalized and responsive learning support that optimizes both cognitive and emotional aspects of learning.

### SUMMARY

In order to solve the above-described problems, a system according to one embodiment of the present invention comprises a processor. The processor is configured to generate, using a generative artificial intelligence model, a learning story based on a curriculum of an educational institution. By doing so, the processor can construct a flexible and individualized sequence of learning content that still conforms to the official curriculum while being automatically organized by the generative artificial intelligence model. Furthermore, the processor is configured to generate a prompt according to a learning progress of a learner and to instruct, by using the prompt, automatic creation of a problem set. In this manner, the processor can cause a problem set to be dynamically generated so that the problem set matches the learner's current stage, recently learned topics, or mastery level. In addition, the processor is configured to recognize, in real time, an emotional state of the learner and to generate a prompt that instructs dynamic adjustment of content of the learning story and of the problem set based on the emotional state of the learner. As a result, the difficulty, volume, or presentation style of the learning story and the problem set can be adaptively modified to maintain or improve the learner's engagement and reduce negative emotions. In another aspect, the processor is configured to score answers of the learner, identify a weakness of the learner based on a scoring result, and generate a prompt that instructs automatic creation of a new problem set including problems for compensating for the weakness. Thus, the processor can provide targeted remedial practice that directly addresses concepts or skills where the learner exhibits insufficient performance. Furthermore, the processor is configured to generate, using the generative artificial intelligence model and a natural language processing technique, a detailed explanation regarding a term or concept that is not understood by the learner, and to provide the detailed explanation to the learner. Consequently, the system can automatically offer individualized, context-aware explanations that support deeper understanding of difficult concepts. Through these means, the system achieves highly adaptive and personalized learning support that dynamically reflects both the learner's cognitive status and emotional state.

The term “system” refers to an arrangement including at least one hardware device and associated software that cooperatively perform the processing defined in the claims.

The term “processor” refers to one or more hardware processing units, such as a central processing unit (CPU), a graphics processing unit (GPU), a microprocessor, or a combination thereof, that execute instructions to perform the functions described in the claims.

The term “generative artificial intelligence model” refers to a machine learning model configured to generate content, such as text or prompts, based on input data, and including, for example, large language models or other neural network models capable of producing new outputs rather than merely selecting from predefined data.

The term “learning story” refers to an ordered or structured sequence of learning content, activities, or topics that guides a learner through a curriculum in a pedagogically meaningful manner.

The term “curriculum of an educational institution” refers to an official or predefined plan of study established by a school, university, or other educational organization, including subjects, units, topics, and their recommended order.

The term “learner” refers to a user of the system who receives learning content, answers problem sets, and interacts with the system for educational purposes.

The term “learning progress” refers to a state or measure indicating how far the learner has advanced in the learning story or curriculum, including information such as completed units, time spent, performance results, and current learning stage.

The term “prompt” refers to data, including textual instructions, parameters, or conditions, that is provided to the generative artificial intelligence model or related components to cause generation of a problem set, an adjustment of content, or an explanation as described in the claims.

The term “problem set” refers to a collection of one or more problems, questions, or exercises that are provided to the learner for practice, assessment, or reinforcement of learning content.

The term “automatic creation” refers to generation or assembly of an output, such as a problem set, by the system without requiring manual selection or editing of each element by a human operator at the time of creation.

The term “emotional state” refers to a psychological condition of the learner, including, for example, states such as engagement, frustration, confusion, boredom, or motivation, which can be recognized by the system in real time through input data.

The term “real time” refers to processing that is performed with a responsiveness sufficient for the system to adapt to the learner's current interactions or conditions without perceptible delay during ongoing use.

The term “dynamic adjustment” refers to modification of content, such as changing the type, difficulty, amount, order, or presentation of learning story elements or problem sets, while the system is in operation, in response to the learner's progress or emotional state.

The term “score” refers to the act of evaluating and determining correctness, partial correctness, or performance level of the learner's answers to problems in a problem set.

The term “weakness” refers to a learning area, topic, concept, or skill in which the learner's performance, as determined by scoring results, does not satisfy a predetermined criterion or falls below a desired proficiency level.

The term “new problem set” refers to a problem set that is generated after analysis of the learner's performance, which is different from previously provided problem sets and is configured to address identified weaknesses.

The term “problem for compensating for the weakness” refers to a problem that is selected or generated so as to target one or more identified weaknesses of the learner and to support improvement in those specific areas.

The term “term or concept that is not understood by the learner” refers to a word, phrase, symbol, or abstract idea appearing in the learning content or problem sets for which the learner indicates a lack of understanding or for which the system determines that the learner requires further explanation.

The term “natural language processing technique” refers to a computational technique for analyzing, understanding, or generating human language, which may include tokenization, parsing, semantic analysis, or text generation, and is used in conjunction with the generative artificial intelligence model to produce detailed explanations.

The term “detailed explanation” refers to an explanatory text or content that describes a term or concept with sufficient depth, including, for example, definitions, intuitive descriptions, examples, and, where appropriate, related formulas or applications, so as to facilitate understanding by the learner.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

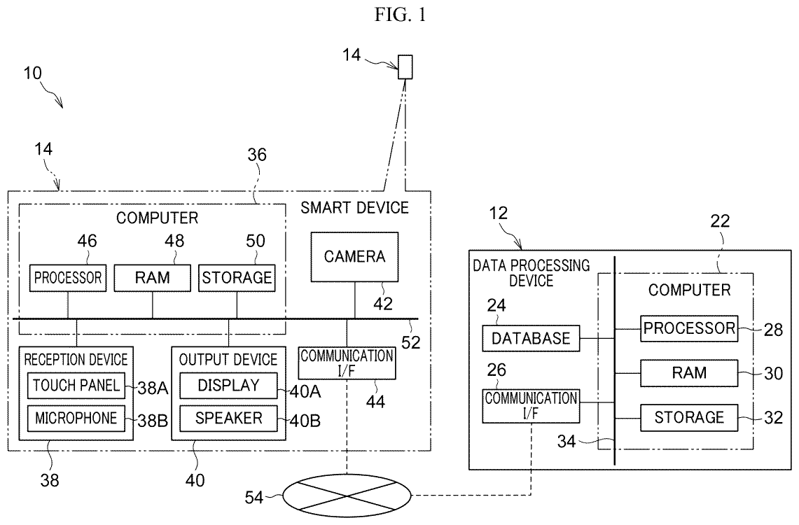

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

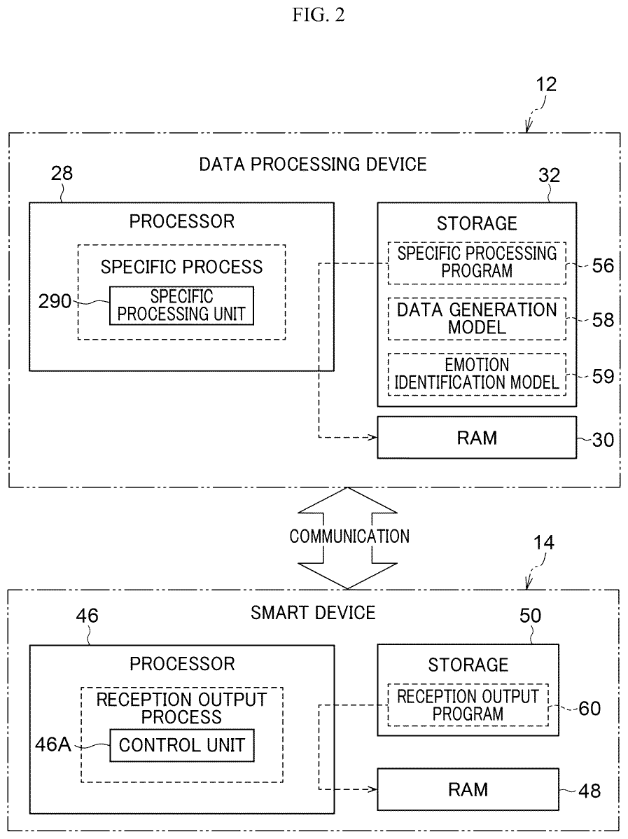

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems mainly deliver static digital content or, at best, content selected from a limited set of pre-authored materials. Even when such systems employ basic user models or rule-based adaptation, they typically suffer from several technical limitations on the computing side. First, the servers in these systems are not architected to dynamically construct and manage rich, machine-generated instructional narratives based on structured curriculum data and fine-grained learner interaction logs. As a result, server-side content generation is either coarse-grained or depends on manual authoring workflows that are not scalable.

Second, conventional systems usually treat communication with a generative AI model, if any, as a one-shot text generation task, without systematic server-side orchestration of prompt sentences that encode curriculum structure, user performance metrics, and context-specific feedback requirements. The absence of a standardized, programmatic prompt-generation pipeline on the server leads to non-deterministic content quality, redundant model calls, and difficulties in reusing or auditing generated content. From a computer technology standpoint, this results in inefficient use of network resources, processing resources, and storage resources, and limits the ability of the server to consistently adapt content in real time. Third, existing platforms often track learner progress at a coarse level (such as completion flags), but do not implement detailed data processing logic on the server to derive concept-level learning achievement indices, error patterns, and weak regions from raw event logs. Without such structured analysis on the server, it is difficult to algorithmically control subsequent content generation. Consequently, the computer system cannot efficiently transform low-level interaction data into high-level control signals that drive adaptive content generation by a generative AI model.

Fourth, while some systems can display explanations or hints, there is typically no integrated server-side mechanism to take specific user operations (such as term selections or explanation requests), translate them into explanation-generation prompt sentences, and call a generative AI model to create targeted, detailed explanation content that is stored, versioned, and provided back to the learner. This disconnect between user interface signals and back-end generative processing prevents the computing system from closing the loop between interaction, analysis, and content regeneration.

In view of the foregoing, there is a need for an improved computer-implemented learning support architecture in which a server is technically configured to: (i) programmatically construct and manage structured prompt sentences from curriculum data and learner state; (ii) coordinate interactions with a generative AI model to obtain learning story-type content, feedback, and additional exercises; (iii) analyze fine-grained learning progress data to compute learning achievement indices and weak regions; and (iv) automatically generate, adapt, and deliver content in response to these indices. Such a system improves the functioning of the server as a technical platform by enabling dynamic, data-driven orchestration of generative AI resources, more efficient storage and retrieval of machine-generated content, and more precise control of adaptive learning flows.

The specific processing by the specific processing unit 290 of the data processing device 12 in Example 1 is realized by the following means.

The present invention provides a server comprising a processor and a memory storing instructions which, when executed by the processor, cause the processor to acquire educational plan information, identify a learning target field and a learning objective based on the educational plan information, generate a prompt sentence including the learning target field and the learning objective, and instruct a generative AI model to generate learning story-type content by using the prompt sentence; receive, from a learning information processing terminal, a request to provide the learning story-type content to a learner, transmit the learning story-type content acquired from the generative AI model to the learning information processing terminal, and store exercise task information and related activity information based on the learning story-type content as structured data; accumulate learning progress data including operation history, answer content, and learning time information of the learner acquired from the learning information processing terminal, calculate a learning achievement index based on the learning progress data, generate an evaluation prompt sentence including the learning achievement index and an identified weak field, and instruct the generative AI model to generate feedback explanation text and additional exercise tasks by using the evaluation prompt sentence; and transmit the feedback explanation text and the additional exercise tasks acquired from the generative AI model to the learning information processing terminal, and generate adaptive learning control information for gradually changing a configuration of the learning story-type content and the exercise tasks in accordance with the learning achievement index. This enables the server to function as an integrated control node that programmatically generates and manages prompt sentences, efficiently coordinates calls to the generative AI model, continuously transforms low-level interaction data into structured learning achievement indices, and dynamically adapts machine-generated instructional content, thereby improving the technical operation of the computer-based learning support system in terms of resource utilization, responsiveness, and precision of personalized content delivery.

The term “educational plan information” refers to electronic information representing a structured curriculum or instructional guideline, including at least a subject area, a grade level or learner level, one or more units or topics, and one or more associated learning objectives.

The term “learning target field” refers to a conceptual or topical domain to be studied by a learner, such as a subject area, a subtopic, or a skill category derived from educational plan information.

The term “learning objective” refers to a goal or expected outcome of instruction that specifies knowledge, skills, or competencies a learner is intended to acquire within a learning target field.

The term “prompt sentence” refers to a machine-generated or machine-processed natural language instruction string that is provided as input to a generative AI model to request generation of specific content.

The term “generative AI model” refers to a trained information processing model that receives input data including a prompt sentence and generates new content data, such as text, based on patterns learned from training data.

The term “learning story-type content” refers to instructional content in a narrative or story-like form that guides a learner through concepts, explanations, examples, and activities oriented toward achieving one or more learning objectives.

The term “learning information processing terminal” refers to an information processing apparatus, such as a computing device operated by a learner, that communicates with a server to present learning content, receive learner inputs, and transmit learning-related data.

The term “exercise task information” refers to data representing one or more questions, problems, or practice tasks, including at least problem statements and optionally answer formats, hints, and solution data.

The term “related activity information” refers to data defining auxiliary learning activities associated with learning story-type content, such as interactive tasks, projects, or exploratory exercises that support the learning objectives.

The term “structured data” refers to data organized according to a defined schema or data model, such as records, fields, and relations, that enables systematic storage, retrieval, and processing by an information processing system.

The term “learning progress data” refers to accumulated data indicating how a learner interacts with learning content, including at least operation history, answer content, and learning time information.

The term “operation history” refers to log data representing user interface operations performed by a learner on a learning information processing terminal, such as content viewing actions, button presses, selections, and navigation events.

The term “answer content” refers to data representing responses provided by a learner to exercise tasks, including textual answers, selected options, or other submitted response information.

The term “learning time information” refers to temporal data indicating durations or timestamps associated with a learner's engagement with learning content, such as time spent per section, per question, or per session.

The term “learning achievement index” refers to one or more computed metrics that quantify a learner's level of understanding or performance with respect to a learning target field or learning objective, derived from learning progress data.

The term “weak field” refers to a learning target field, subtopic, or concept in which a learner's performance or learning achievement index falls below a predetermined threshold, indicating insufficient understanding.

The term “evaluation prompt sentence” refers to a prompt sentence that includes at least a learning achievement index and a weak field and that is provided to a generative AI model to request generation of evaluative or feedback-oriented content.

The term “feedback explanation text” refers to text generated by a generative AI model that explains a learner's errors, misconceptions, or performance and provides guidance or clarification to improve understanding.

The term “additional exercise tasks” refers to exercise tasks generated after analysis of learning progress data, intended to further train or remediate a learner, especially in relation to a weak field.

The term “adaptive learning control information” refers to control data that specifies how to modify, sequence, or select learning story-type content and exercise tasks in response to a learner's learning achievement index.

The term “answer history” refers to a series of answer content records associated with one or more exercise tasks over time for a given learner or learning session.

The term “scoring processing” refers to computational processing that evaluates answer content against correct answers or scoring rules to determine correctness, partial correctness, or a numerical score.

The term “incorrect answer tendency” refers to a pattern or statistical measure derived from answer history indicating recurring types of errors or misconceptions exhibited by a learner.

The term “correctness rate for each concept” refers to a metric calculated by grouping exercise tasks by concept and computing a ratio of correctly answered tasks to total tasks attempted for each concept.

The term “weak region” refers to a subset of concepts, skills, or topics identified by analyzing scores, incorrect answer tendencies, or correctness rates, where a learner shows lower performance relative to other regions.

The term “problem-generation prompt sentence” refers to a prompt sentence that includes information about at least a weak region, a supplementary explanation request, and target difficulty information, and that is used to instruct a generative AI model to generate a problem set.

The term “supplementary explanation request” refers to an instruction element within a prompt sentence that directs a generative AI model to produce additional or more detailed explanatory content for a specific topic or weak region.

The term “target difficulty information” refers to data specifying a desired difficulty level or range for generated exercise tasks or explanations, such as beginner, intermediate, or advanced levels.

The term “problem set for reinforcing the weak region” refers to a group of exercise tasks generated to specifically address a weak region, designed to improve a learner's understanding and performance in that region.

The term “term selection operation information” refers to operation history data indicating that a learner has selected, highlighted, or otherwise indicated interest in a particular term or phrase within learning content.

The term “explanation request operation information” refers to operation history data indicating that a learner has explicitly requested an explanation or further details, such as by activating a help or explanation function.

The term “difficult-to-understand term” refers to a term in the learning content that is inferred to be not well understood by a learner based on term selection operation information, explanation request operation information, or learning achievement indices.

The term “difficult-to-understand concept” refers to a concept in the learning content that is inferred to be not well understood by a learner based on interaction data or performance metrics associated with that concept.

The term “explanation-generation prompt sentence” refers to a prompt sentence that includes at least a difficult-to-understand term or a difficult-to-understand concept and a corresponding learning achievement index, and that is used to request detailed explanation content from a generative AI model.

The term “detailed explanation content” refers to explanatory text generated by a generative AI model that provides expanded, step-by-step, or example-based explanations for a term or concept identified as difficult to understand.

The term “natural language processing” refers to processing performed by an information processing system that analyzes, interprets, or generates human language data, including at least the generation of text by a generative AI model based on a prompt sentence.

In one embodiment, a server, a terminal, and a user cooperate to implement the invention. The server includes at least one processor, a main memory, a non-volatile storage device, and a network interface. The server runs on general-purpose computer hardware, for example an x86_64 architecture server with a multi-core CPU (such as a processor of the server class), volatile memory (for example, DRAM), and non-volatile storage (for example, SSDs). The server executes an operating system such as a Unix-like server operating system and application software such as a web application framework implemented in a programming language such as Python or JavaScript. The server further includes a database management system, for example a relational database such as PostgreSQL or MySQL, and an HTTP server component to communicate with the terminal via a communication network. The server stores educational plan information, learning story-type content, exercise task information, related activity information, learning progress data, and feedback content in structured data form. The server uses relational database tables with defined schemas, for example a “curriculum” table, a “learning_content” table, an “exercise_task” table, a “learning_logs” table, a “user_progress” table, and a “feedback_content” table. The server associates records using foreign keys, such as mapping user identifiers to progress records and mapping curriculum identifiers to generated content entries. By structuring data in this way, the server enables efficient indexed retrieval for prompt sentence construction and for generation of adaptive learning control information.

The server communicates with a generative AI model that is implemented as a neural network model hosted on an AI service infrastructure. In one embodiment, the generative AI model is a transformer-based language model with multiple encoder-decoder or decoder-only blocks, multi-head self-attention layers, and feed-forward layers. The generative AI model is trained on large-scale textual data using supervised and self-supervised learning methods. During training, the generative AI model minimizes a loss function such as a cross-entropy error between predicted token distributions and ground-truth tokens, and updates network parameters (weights and biases) using gradient-based optimization algorithms such as stochastic gradient descent or variants thereof. The generative AI model internally represents tokens as vectors in an embedding space, applies positional encoding, and processes sequences of tokens in fixed-length segments (for example, up to several thousand tokens). The generative AI model maintains parameters such as layer depth, hidden dimension size, number of attention heads, and vocabulary size, which can be set in accordance with required performance and latency constraints.

The server accesses the generative AI model via an application programming interface (API) over a secure network protocol such as HTTPS. The server generates a prompt sentence in natural language and transmits the prompt sentence as part of a request body in a defined data structure (for example, a structured message object) to the generative AI model. The server controls parameters for content generation such as temperature, repetition penalties, and maximum output length. The generative AI model processes the prompt sentence using its internal attention mechanism, selects token probabilities according to the learned parameters, and outputs a sequence of tokens which the model decodes into a text string. The server receives this text string and interprets it as learning story-type content, feedback explanation text, additional exercise tasks, or detailed explanation content, depending on the nature of the prompt sentence.

The server generates prompt sentences through algorithmic processing that goes beyond manual description or naive concatenation of text. The server first retrieves educational plan information from the “curriculum” table, including fields such as grade level, subject, unit title, and learning objectives. The server then uses a rule-based template system, in which placeholders in parameterized sentence patterns are filled with curriculum fields and computed parameters such as target difficulty. For example, the server generates a prompt sentence in the form:

“Based on the first-year high school mathematics curriculum, create a step-by-step learning story that teaches methods for solving linear equations. Cover the following learning objectives: [learning objective list]. Use clear explanations, simple examples, and 5 practice questions with answers.”

The server also generates evaluation-oriented prompt sentences by embedding computed metrics into the text. After the server calculates a learning achievement index, error rates, and weak regions, the server generates an evaluation prompt sentence such as:

“For the topic ‘solving linear equations’ in the first-year high school mathematics curriculum, the student answered only 3 out of 10 questions correctly involving moving terms across the equal sign and required hints on 4 questions. Create a short feedback message to explain the student's mistakes, provide clear step-by-step guidance, and generate 3 additional targeted practice problems with solutions.”

In one variation, the server generates an explanation-oriented prompt sentence when a learner selects a term or requests an explanation, such as:

“The student does not fully understand the term ‘linear equation’ and related concepts. Using language appropriate for a first-year high school student, explain what a linear equation is, how to recognize it, and provide 3 example problems with explanations.”

By systematically converting structured data and quantitative metrics into prompt sentences through templates and algorithmic insertion of values, the server ensures reproducibility and consistency, while controlling prompt length and structure to reduce bandwidth and processing overhead at the generative AI model side.

The terminal is implemented as a general-purpose information processing apparatus, such as a smartphone, tablet, notebook computer, or desktop computer. The terminal includes at least one processor, a memory, a display device, an input device (for example, a touch panel or keyboard), and a communication module that supports wireless or wired networking. The terminal executes an operating system of a client type and a learner-facing application. The learner-facing application may be implemented as a native application (for example, an application written in a native programming language for a mobile platform) or as a web application executing within a browser.

The terminal receives learning story-type content, exercise tasks, related activities, and feedback content from the server, and displays them to the user. The terminal renders text, images, and interactive components using a graphical user interface toolkit. The terminal provides input fields for the user to enter answers to exercise tasks, buttons to request hints or detailed explanations, and navigation controls to move among sections of the learning story-type content. The terminal records detailed user interaction events, such as timestamps when content is displayed, when answers are submitted, when hints are requested, and when specific terms are selected. The terminal aggregates these events in memory into structured event objects and periodically transmits learning progress data to the server. This design reduces network overhead by batching multiple events into a single transmission, thereby reducing communication load compared to sending raw events individually.

The user interacts with the terminal by reading the displayed learning story-type content, following explanations, and answering exercise tasks. The user selects terms or presses an explanation request control when unfamiliar terminology or concepts appear. The user's operations cause the terminal to generate event data, which the terminal encodes as learning progress data, and transmits to the server. The user thereby indirectly controls the generation of feedback explanation text and additional exercise tasks, without manually designing or formulating such content.

The server processes learning progress data to compute learning achievement indices and to identify weak fields or weak regions. The server obtains answer content and scoring information for each exercise task. The server performs scoring either locally or by using predefined scoring rules stored in the database. For example, the server compares a learner's text answer with stored correct answers using exact match, pattern matching, or tolerance-based numerical comparison. The server calculates concept-wise correctness rates by grouping exercise tasks by associated concept tags stored in the “exercise_task” table. The server also computes temporal metrics such as average time per question and number of hints requested. The server applies rule-based thresholds, such as classifying a concept as weak when the correctness rate is below a set value and the hint usage exceeds a certain count. In another embodiment, the server uses statistical models or machine learning models to refine the interpretation of learning progress data. The server may use a classifier that is trained to estimate a discrete understanding level (“high”, “medium”, “low”) based on feature vectors derived from progress data. Features may include correctness rate, variance in response time, number of attempts per question, and frequency of explanation requests. The server trains such a classifier offline using labeled historical data, minimizing a loss function such as cross-entropy or mean squared error between predicted and reference labels, and updates parameters using gradient-based optimization. At runtime, the server loads the trained model parameters into memory and performs inference by applying matrix multiplications and non-linear activations on the feature vectors. By doing so, the server transforms raw logs into higher-level indices that capture nuanced aspects of learner behavior, and thereby generates more precise and individualized prompt sentences. The server generates adaptive learning control information by combining learning achievement indices and generated content metadata. For each learner and topic, the server stores a current difficulty level, content version identifiers, and priorities among various subtopics. When the server identifies a weak region, the server increases the relative weight of that region in the subsequent content selection and generation process. The server may adjust the number of practice tasks, the complexity of numerical values, or the presence of step-by-step hints. The adaptive control information is represented as structured parameters (for example, difficulty codes, required coverage flags, and maximum hints) and is embedded into subsequent prompt sentences. As a result, the server does not simply repeat content, but reconfigures the internal control parameters of content generation in a way that changes the generative AI model's output distribution.

The server thereby improves computer technology in several ways. By generating prompt sentences from structured data using defined templates and rule-based transformations, the server constrains the prompt space and avoids redundant or excessively verbose prompts, which reduces data size per model call and lowers network bandwidth usage. The server stores generated content and associated prompt sentences in indexed tables, enabling reuse of suitable content instead of always invoking the generative AI model, which reduces computational load at the AI service. The server optimizes the timing of API calls, for example by aggregating multiple feedback requirements into a single prompt sentence when appropriate, which reduces the number of network round trips and improves overall system responsiveness. The server further uses learning achievement indices to limit the scope of content requested from the generative AI model to specific weak regions, thereby reducing the required output length and improving processing efficiency.

The server also implements specific control over the generative AI model's parameters. For instance, the server sets a higher maximum output length when generating initial learning story-type content, and a lower value when generating short feedback messages, which reduces unnecessary token generation and associated inference time. The server may lower the temperature parameter during feedback generation to ensure deterministic, reproducible instructions, which simplifies caching and verification. These parameter choices are not mere content preferences; they directly influence processing time, memory usage, and determinism, and therefore contribute to the improved technical operation of the system. The system uses AI in a manner that is distinct from simple automation of human instructional authoring. The server does not merely replace manual drafting with automated text generation; rather, the server redesigns the internal data structures and control flow of a learning support system so that the generative AI model becomes an integrated processing component triggered by precise, data-driven instructions. The server's approach to generating and managing prompt sentences introduces non-conventional control logic, wherein the server dynamically adjusts prompt content and model parameters based on quantitative indices and event-derived features. This approach improves the computer system's ability to transform diverse and high-volume learning logs into concise and targeted model requests, achieving reductions in processing latency and improving the relevance and structure of responses.

In some embodiments, the neural network for the generative AI model is trained using data augmentation techniques that enhance its ability to handle educational content. The training system may augment input examples by paraphrasing problem statements, synthetically generating incorrect answers, or rearranging explanation sequences, thereby exposing the model to a wide variety of phrasing and error patterns. The training process uses a combination of teacher-forced decoding and self-supervised language modeling across such augmented data. By leveraging a model that has been specifically tuned for structured educational tasks, the server receives more stable and context-appropriate responses and can maintain a simpler layer of post-processing logic.

In one alternative embodiment, the server locally hosts a smaller generative AI model on the same physical machine or in a closely coupled cluster. The server loads model parameters into main memory and performs inference using a dedicated processing unit, such as a GPU or a specialized tensor processing unit. The server segments incoming prompt sentences into tokens using a tokenizer, maps tokens to embeddings, and executes a forward pass through the transformer network. The server then decodes the output logits into tokens using greedy decoding or beam search, depending on desired response diversity and speed. In this configuration, the server obtains tighter control over latency and can integrate inference scheduling with other server tasks.

In another alternative embodiment, the server constructs part of the content using deterministic algorithmic rules and uses the generative AI model for only certain segments, such as narrative intros or detailed explanations. For example, the server may generate the numerical values and algebraic structure of linear equation problems algorithmically, ensuring controlled difficulty and reproducible evaluation, and then ask the generative AI model, via a prompt sentence, to provide natural language explanations for the solutions. This hybrid approach allows the server to improve accuracy and consistency of scoring, while still benefiting from the generative AI model's ability to produce varied and engaging textual explanations.

The system can also implement variations in terminal configuration. In one variation, the terminal is a dedicated learning appliance with limited local processing and display hardware optimized for low power consumption. The server offloads most processing to a central data center and transmits only compressed and pre-structured content to the terminal. In another variation, the terminal performs partial scoring locally for low-latency feedback, using rules or lightweight models cached from the server. In each case, the server remains the primary node responsible for generating prompt sentences, invoking the generative AI model, and maintaining the unified state of learning content and progress metrics.

By structuring data into normalized tables, by algorithmically generating prompt sentences that reflect real-time learning achievement indices, and by controlling generative AI inference parameters in a non-conventional, data-driven manner, the server improves processing efficiency, accuracy of adaptation, and network resource usage. The cause-and-effect relationship between these structural and algorithmic choices and the resulting technical effects can be summarized as follows: the server's structured representation of curriculum and learner data reduces search and retrieval complexity; the server's prompt-generation logic reduces unnecessary text payload and prevents redundant model invocations; the server's adaptive control over AI parameters reduces average inference time and memory usage; and the server's feedback loop from logs to indices to prompts enables more precise and narrower-scope content generation, which further decreases processing overhead and improves the specificity and helpfulness of the generated content.

Accordingly, the embodiments described above allow other practitioners skilled in the art of computer-implemented learning systems, natural language processing, and neural network inference to implement the claimed invention on general-purpose or specialized hardware, adapt it to different educational domains, and modify the underlying generative AI model architecture while maintaining the core technical contribution of structured prompt-based control, adaptive content generation, and efficient server-side orchestration.

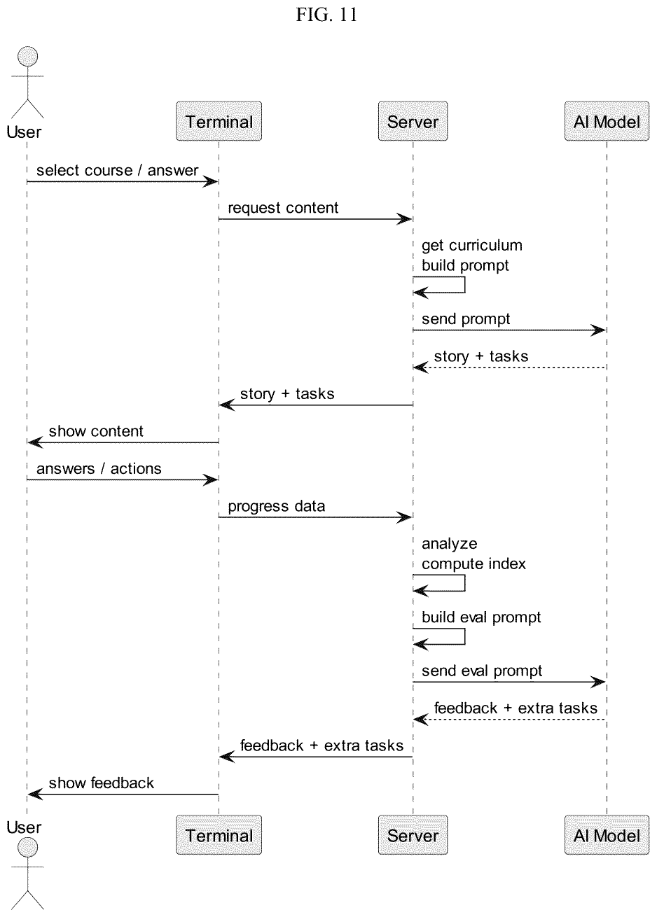

The following describes the processing flow using FIG. 11.

### Step 1:

Server acquires educational plan information as input from a storage device or an external curriculum management system. Server receives structured data including fields such as subject identifier, grade level, unit title, and learning objectives. Server parses this data and stores it in a curriculum table in a relational database, indexing by subject and grade. As a result of this data processing, server outputs normalized curriculum records that can be efficiently retrieved for later prompt sentence construction.

### Step 2:

Server retrieves relevant curriculum records as input based on a user's requested subject, grade, and unit. Server executes SQL queries to select the learning target field and associated learning objectives. Server then performs string formatting operations to generate a base prompt sentence. For example, server combines unit title and objectives to produce output such as: “Based on the first-year high school mathematics curriculum, create a step-by-step learning story that teaches methods for solving linear equations. Cover the following learning objectives: [list of objectives].” This processing converts structured curriculum data into a natural-language prompt sentence.

### Step 3:

Server acquires user profile information and current learning status as input from a user_profile table and a user_progress table. Server reads fields such as past scores, previously identified weak fields, and preferred difficulty level. Server then integrates these values into the base prompt sentence by inserting numerical indicators and weak-topic descriptions into designated template positions. The output of this step is a user-adapted prompt sentence that reflects both curriculum structure and the individual learner's performance characteristics.

### Step 4:

Server sends the adapted prompt sentence as input to a generative AI model via an API call. Server constructs a request object containing the prompt sentence, a model identifier, and parameters such as temperature and maximum token length, and transmits it over HTTPS. Server uses an HTTP client library to send the request and manages API keys and headers. The generative AI model processes the prompt sentence and returns generated text as output. Server receives this output as a JSON response and extracts the generated learning story-type content string.

### Step 5:

Server parses the generated learning story-type content as input and segments it into sections such as introduction, concept explanation, example problems, and practice questions. Server uses text processing routines to detect headings, numbered lists, and question markers. Server then converts each detected section into structured records and writes them into a learning_content table and an exercise_task table. The output of this step is a set of database records that represent the narrative content and exercise tasks in a machine-readable structured form.

### Step 6:

Terminal sends a content request as input to the server, including user identifier, requested subject, and unit. Server receives this request and queries the learning_content and exercise task tables to fetch the corresponding structured content. Server aggregates the records into a response object, orders the sections according to a predefined layout, and outputs a content package containing narrative text, tasks, and activity descriptors. Server transmits this package to the terminal over HTTPS.

### Step 7:

Terminal receives the content package as input and parses the structured fields into internal data objects. Terminal maps each section and exercise task to user interface components, such as text views, question cards, and answer input fields. Terminal then renders the narrative and tasks on the display device. The output of this step is a displayed learning story and interactive exercise interface that the user can read and manipulate.

### Step 8:

User reads the displayed learning story as input and performs operations such as scrolling, selecting content sections, and choosing which exercises to answer. User enters answer content into input fields and may tap buttons to request hints or explanations for specific terms. The output of this step is a set of user-generated inputs including text answers, selected options, and explanation requests, which the terminal captures as interaction events.

### Step 9:

Terminal records user interactions and answer content as input events in local memory. Terminal attaches timestamps to each event, such as the time when a question was first displayed and when an answer was submitted. Terminal then groups these events into learning progress data structures, calculating derived values such as time spent per question by subtracting display time from submission time. The output is a compact learning progress report containing operation history, answer content, and learning time information.

### Step 10:

Terminal sends the learning progress report as input to the server over HTTPS. Server receives the report, validates its format, and writes raw event records into a learning_logs table. Server also aggregates the data by exercise and concept, computing counts of attempts and recorded times. The output is updated learning_logs and preliminary aggregates that are stored in the database for further analysis.

### Step 11:

Server retrieves the aggregated learning progress data as input from the database to compute learning achievement indices. Server calculates metrics such as correctness rate per concept, average response time, number of hints requested, and number of retries for each exercise. Server applies rule-based thresholds to classify each concept into levels such as strong or weak. The output of this step is a set of learning achievement indices and identified weak fields associated with the user and the current unit.

### Step 12:

Server constructs an evaluation prompt sentence using the learning achievement indices and weak fields as input. Server formats sentences that embed specific statistics, such as “3 out of 10 correct” or “hints requested on 4 questions,” into an explanatory template. For example, server may output: “For the topic ‘solving linear equations,’ the student answered only 3 out of 10 questions correctly involving moving terms across the equal sign and required hints on 4 questions. Create a short feedback message to explain the student's mistakes, provide clear step-by-step guidance, and generate 3 additional targeted practice problems with solutions.” This processing converts numerical analytics into a natural-language prompt sentence suitable for the generative AI model.

### Step 13:

Server sends the evaluation prompt sentence as input to the generative AI model via the same API interface used previously, but with adjusted parameters (for example, lower temperature and shorter maximum token length) to obtain concise and deterministic feedback. The generative AI model processes the evaluation prompt sentence and returns generated feedback explanation text and additional exercise tasks as output. Server receives and parses this response and separates feedback paragraphs from newly generated question items.

### Step 14:

Server writes the feedback explanation text and additional exercise tasks as input into feedback_content and exercise task tables. Server associates each record with user identifier, topic, and timestamp. Server also generates adaptive learning control information by updating control parameters such as current difficulty level, number of required practice tasks, and emphasis on specific weak regions. The output of this step is a set of updated database records that guide future content selection and prompt sentence generation for the same user.

### Step 15:

Server retrieves the latest feedback explanation text, additional exercise tasks, and adaptive learning control information as input when the terminal requests updated content. Server bundles these elements into a response object, ordering feedback and new tasks according to the control parameters (for example, placing explanations before exercises for weak regions). Server outputs this feedback package to the terminal, along with metadata indicating which tasks are mandatory and which are optional.

### Step 16:

Terminal receives the feedback package as input and updates the displayed interface. Terminal shows the feedback explanation text prominently and inserts the additional exercise tasks into the task list, tagging them as recommended practice for specific weak topics.

Terminal uses the adaptive learning control information to adjust the sequence of sections or to highlight particular tasks. The output is an updated, personalized learning screen that directs the user's attention to areas needing improvement.

### Step 17:

User reviews the feedback explanation text as input and attempts the additional exercise tasks. User applies the step-by-step guidance to solve new problems and submits answers through the terminal interface. The output of this step is a new set of answered tasks and interaction events that reflect the user's changed understanding.

### Step 18:

Terminal records the new answers and interaction events as input into another learning progress report. Terminal again computes derived metrics such as improved correctness rates and reduced hint usage for the weak regions. Terminal sends this updated report to the server. Server receives the report, repeats the analysis of learning achievement indices, and updates weak field classifications. The output is an updated learner model that reflects progress after feedback, which the server then uses to generate refined prompt sentences and content in subsequent iterations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically rely on static course flows and rule-based adaptation, which limits their ability to exploit learner data in a fine-grained, real-time manner. A typical system stores curriculum content in a database and delivers fixed sequences of lessons and questions to a user terminal. Even when some limited personalization is attempted, such as selecting questions by difficulty level, these operations are usually implemented as simple filtering or branching logic executed on the server. As a result, the underlying computing architecture does not fully utilize modern machine-learning and generative artificial intelligence capabilities to improve the operation of the computer system itself.

In particular, existing systems present the following technical limitations.

First, a conventional learning server generally treats curriculum data as static content and does not dynamically construct or reconfigure a “learning story” as a structured data object that is continuously optimized. The server often cannot integrate diverse, time-series progress data (e.g., answer history, response latency, interaction logs) into a unified internal representation that can drive continuous reconfiguration of learning sequences without manual intervention. This leads to inefficient use of storage and processing resources, because learning paths are not re-computed in a data-driven manner but are instead retrieved as pre-defined templates.

Second, conventional systems that generate or select problem sets tend to use simple heuristics (for example, selecting questions tagged with a given difficulty). These systems are not architected to generate machine-readable instructions (such as prompt sentences and meta prompts) as internal control signals to downstream AI components. Consequently, the server cannot systematically orchestrate a generative AI model as a callable subsystem that receives structured prompts derived from learner state, and returns text outputs that are then programmatically post-processed to create machine-consumable problem-set data. This limits the ability of the server to automatically and robustly create tailored problem sets in real time. Third, prior systems do not efficiently integrate multimodal learner state information such as behavioral logs, biometric inputs, and facial cues into a single emotional-state estimation pipeline that feeds back into content orchestration. Typically, emotion detection, if present at all, is an isolated feature and does not act as a control input for learning-path scheduling, problem-set difficulty adjustment, or prompt generation. As a result, the server's scheduling and content-adjustment logic is not optimized to run as an adaptive control loop over these inputs, and the use of computational resources for personalization remains limited.

Fourth, existing systems that provide explanations for unknown terms or concepts frequently rely on fixed glossaries or static text retrieval. Even if a generative AI model is used, such usage is often ad hoc, and the server does not maintain a structured mechanism for generating and managing meta prompts and post-processing generated texts into standardized explanation objects. This hinders the server's ability to reuse, cache, and systematically update explanations and prevents a unified pipeline from being established for explanation generation and delivery.

Fifth, conventional architectures generally treat generative AI outputs as final user-facing content and do not utilize them as control primitives. There is typically no well-defined layer in which the server algorithmically generates meta prompts based on learner-feature vectors, calls a generative AI model as a service, and then post-processes outputs into internal representations such as individualized prompt sentences or learning-story update instructions. As a result, the computer system cannot fully leverage generative AI as a programmable component that directly optimizes internal scheduling, caching, and data-structure configurations.

Accordingly, there is a need for an improved computer-implemented learning support system in which a server is specifically configured to (i) maintain and update a structured learning story optimized over time using accumulated progress data, (ii) generate and consume meta prompts and prompt sentences as machine-readable control instructions for generative AI models and content-assembly modules, (iii) estimate and utilize emotional states and fine-grained progress metrics as control inputs for dynamic scheduling and difficulty adjustment, and (iv) standardize the generation and post-processing of AI-generated texts into reusable data objects. By addressing these issues, the invention aims to improve the operation of the server itself, including its data flow, control logic, and integration with generative AI models, thereby providing a more efficient, scalable, and adaptive computer system for learning support.

The specific processing by the specific processing unit 290 of the data processing device 12 in Application Example 1 is realized by the following means.

The present invention provides a server comprising a processor configured to acquire educational information from a storage unit and generate, as structured data, a template learning story including learning units and learning order, to receive, from a terminal device, progress data including answer contents, answer time, and operation history of a learner and to calculate, from the progress data, a comprehension index and weak concepts, to generate meta prompts as machine-readable control instructions to be input to a generative AI model on the basis of at least the educational information and the progress data, to execute a generative AI process using the generative AI model so as to obtain text generation results, to perform post-processing on the text generation results so as to generate standardized internal objects including prompt sentences that instruct or guide a next learning action and problem-set definitions that specify problem texts, option information, and answer information, to dynamically adjust at least one of order, amount, or difficulty of the learning story and the problem-set definitions on the basis of the comprehension index, the weak concepts, and an estimated emotional state of the learner derived from at least one of behavioral information, biometric information, or facial information received from the terminal device, and to continuously update and store the learning story and generation conditions of the prompt sentences by feeding back reactions of the learner to the presented learning story, problem sets, and prompt sentences. This enables the server to operate as an adaptive control platform in which learning stories, problem sets, and prompt sentences are represented as modifiable data structures, in which meta prompts and generative AI outputs are used as internal control primitives, and in which learner progress data and emotional-state information are continuously integrated into scheduling and content-generation pipelines, thereby improving the efficiency, scalability, and personalization capabilities of the computer system itself.

The term “educational information” refers to electronic content data representing instructional materials, curriculum structures, lesson descriptions, assessment items, and associated metadata used for planning and delivering learning activities.

The term “information storage unit” refers to a hardware or software storage resource, such as a database system or file storage system, that persistently stores educational information, learner data, and system configuration data.

The term “learning story” refers to a structured representation of a learning path that specifies an ordered sequence of learning units, including topics, lessons, and activities, together with their relationships, prerequisites, and transitions.

The term “template of a learning story” refers to a generic learning story structure generated from educational information, prior to personalization, which defines candidate learning units, their order, and their dependency relationships for a category of learners or a course.

The term “learning unit” refers to a discrete instructional segment, such as a topic, lesson, exercise, or activity, that can be individually scheduled, presented, and evaluated within a learning story.

The term “learning order” refers to a defined sequence or scheduling rule that determines the relative position and progression of learning units within a learning story.

The term “terminal device” refers to an end-user computing device, such as a mobile device, a tablet, or a personal computer, that executes client software to present learning content and user interfaces to a learner and to communicate with the server.

The term “progress data” refers to electronically recorded information about a learner's interaction with learning content, including answer contents, answer time, operation history, navigation behavior, and other logs indicative of learning progress.

The term “answer contents” refers to the specific responses or input values provided by the learner to questions, tasks, or prompts presented by the system.

The term “answer time” refers to a time-related measurement indicating how long the learner takes to respond to a question or to complete a task, typically recorded as an absolute time stamp or an elapsed duration.

The term “operation history” refers to logged interaction events generated by the learner at the terminal device, including selections, taps, clicks, scrolls, navigation actions, and control operations performed within the learning interface.

The term “comprehension index” refers to a computed numerical or categorical indicator that estimates a learner's level of understanding or mastery with respect to a concept, topic, or learning unit, based on progress data.

The term “weak concept” refers to an instructional concept or skill whose associated comprehension index or achievement index for a learner falls below a predetermined threshold, indicating insufficient understanding.

The term “problem set data” refers to a collection of structured problem data items, each including problem text, option information, and answer information, that together constitute a set of questions to be presented to the learner.

The term “problem data” refers to a structured data item representing an individual question or exercise, including at least problem text, one or more candidate options if applicable, and corresponding answer information.

The term “problem text” refers to textual content or equivalent machine-readable representation of the question statement or task description to be presented to the learner.

The term “option information” refers to data defining one or more selectable answer choices for a problem, including the textual content of each choice and optional metadata such as choice identifiers or ordering.

The term “answer information” refers to data specifying the correct answer or acceptable range of answers for a problem, and may further include scoring rules or evaluation criteria.

The term “prompt sentence” refers to a natural-language text string generated by the server, intended to instruct, guide, or encourage the learner regarding a next learning action, a problem-solving approach, or a content selection.

The term “meta prompt” refers to a machine-readable text or structured instruction generated by the server and used as input to a generative AI model, describing learner state, context, and desired output characteristics to control the model's text generation.

The term “generative AI model” refers to a trained machine-learning model configured to generate text or equivalent content in response to an input such as a meta prompt, and implemented using statistical or neural-network-based techniques.

The term “text generation result” refers to one or more text outputs produced by the generative AI model in response to a meta prompt or other input, prior to any post-processing or formatting by the server.

The term “post-processing” refers to operations performed by the server on the text generation result, including at least filtering, editing, formatting, structuring, or validating the text so as to convert it into standardized internal data objects such as prompt sentences or problem definitions.

The term “current learning state” refers to a representation of the learner's present position and status within the learning story, including at least the active learning unit, recent performance, and related progress metrics.

The term “biological information” refers to sensor-based measurements related to the learner's physiological state, such as heart rate, skin conductance, or similar biometric signals, when such signals are available to the system.

The term “behavior information” refers to quantitative or qualitative data about the learner's usage behavior, including interaction patterns, session duration, pacing, and response timing, as derived from operation history and related logs.

The term “facial information” refers to image data, video data, or derived features obtained from such data that represent the learner's facial expressions or movements, as detected or captured by a camera associated with the terminal device.

The term “emotional state” refers to an inferred affective condition of the learner, such as engagement, frustration, confidence, or boredom, estimated by the server on the basis of at least one of biological information, behavior information, or facial information.

The term “detailed explanation text” refers to a natural-language text generated or selected by the server, providing an extended or supplementary description of a term or concept, optionally including definitions, examples, and clarifications.

The term “term information” refers to data specifying a particular word, phrase, symbol, or expression selected or queried by the learner within the learning content.

The term “learning context information” refers to data describing the instructional situation in which a term or concept appears, including at least the current subject, topic, problem, or learning unit in which the term is used.

The term “reaction of the learner” refers to observed or recorded responses to presented learning content, problem sets, or prompt sentences, including answer behavior, navigation choices, acceptance or rejection of suggestions, and subsequent performance changes.

The term “generation conditions of the prompt sentences” refers to configuration parameters or rules used by the server to construct meta prompts and to interpret generative AI outputs, such as target length, tone, complexity level, and emphasis on certain actions.

The term “learning path” refers to an individualized sequence or structure of learning units and associated activities that is determined and updated by the server for a particular learner, based on the learning story, progress data, and personalization logic.

The term “achievement index” refers to a computed performance metric for a learner with respect to a concept or learning unit, derived from correctness information, answer time, or related progress data, and used to assess learning outcomes.

The term “correctness information” refers to data indicating whether a learner's answer to a problem is correct, incorrect, partially correct, or otherwise categorized according to predefined evaluation criteria.

The term “difficulty change” refers to an adjustment in the complexity level or challenge level of problems or learning units selected for the learner, performed by the server based on learner state.

The term “insertion of review” refers to an operation in which the server modifies the learning story or learning path to add one or more review-oriented learning units or problem sets before or between existing units.

The term “viewing of an additional explanation” refers to a system-driven prompt or action that causes the learner to access supplementary explanatory content, such as a detailed explanation text for a term or concept.

The term “individualized prompt sentence” refers to a prompt sentence that has been generated or selected specifically for a single learner, based on that learner's current learning state, progress data, weak concepts, and, optionally, emotional state.

In one embodiment, a server, a terminal, and a user cooperate to implement the invention.

The server includes at least one processor, a main memory, a non-volatile storage device, and a network interface. The server executes server-side software implemented, for example, in a scripting language such as Python running on an operating system such as a general-purpose server operating system. The server connects to a data management system such as a relational database management system that stores educational information, learner information, and configuration information. The server also connects to an accelerator such as a graphics processing unit or a tensor computation unit for executing a generative AI model.

The terminal includes a processor, a display, an input device such as a touch panel, a microphone, a camera, a main memory, and a network interface. The terminal executes client software implemented, for example, using a cross-platform framework such as a component-based user interface framework. The terminal communicates with the server via a network such as a wireless network and a packet-switched network. The user operates the terminal to view learning content, input answers, and request explanations.

The server stores educational information in the database as structured records. The server represents curriculum elements such as subjects, topics, and lessons using tables with fields for identifiers, prerequisite relationships, difficulty levels, and tags. The server represents a learning story as a graph-like data structure in which nodes correspond to learning units and edges correspond to transitions and prerequisites. The server stores the learning story in the database using table relations or a serialized structured format.

The server constructs a template of a learning story by reading educational information from the database and mapping it into an internal representation. The server uses a structured data model such as an object graph or a nested dictionary to represent units, sequences, and conditions. The server normalizes the data to separate static curriculum definitions from user-specific paths. This specific data modeling permits efficient re-computation and partial updates of the learning story, which improves processing speed when many users access the system concurrently.

The server maintains learner-related data in the database as progress data. The server stores, for each learner and each problem, the answer content, an indicator of correctness, timestamps, elapsed answer time, the identifier of the learning unit, and interaction events such as navigation operations. The server indexes these records by user identifier and concept identifier so that queries over performance per concept and per time window can be executed using efficient index scans. This structure enables the server to compute comprehension indices and weak concepts in near real time even for large data volumes, which improves scalability.

The server implements a generative AI model using a numerical computation framework such as a tensor computation library. In one embodiment, the generative AI model is a transformer-based neural network. The server defines an encoder-decoder architecture having multiple attention layers. The server represents input tokens as embeddings and applies positional encodings. The server trains the model offline using a corpus of instructional prompt sentences and learner-state descriptions. During training, the server minimizes a loss function such as cross-entropy between predicted token distributions and ground-truth tokens. The server updates model weights using a gradient-based optimization algorithm such as stochastic gradient descent with adaptive learning rate. The server may perform data augmentation by paraphrasing training sentences or by injecting synthetic learner-state descriptors to increase robustness.

The server configures the generative AI model to accept meta prompts as input. The server formats a meta prompt as a text sequence that encodes learner features and requested output characteristics. For example, the server may generate a meta prompt such as:

“The learner is studying quadratic equations. The learner has 80% accuracy on factoring but only 50% accuracy on using the quadratic formula. The learner took a long time on the last three problems. Generate a short, encouraging prompt sentence that suggests the next step and mentions the quadratic formula.”

The server converts this meta prompt into tokens, passes them to the input layer of the generative AI model, and obtains a text generation result as a sequence of output tokens. The server decodes the tokens to characters, applies constraints such as maximum length and allowed vocabulary, and removes any content that does not satisfy internal policies. By defining a fixed structure for meta prompts and by fixing decoding parameters such as beam width and temperature, the server ensures stable latency and predictable output characteristics. This contributes to improved responsiveness and reliability of the system compared to ad hoc text generation.

The server also implements a separate prediction pipeline that calculates comprehension indices and weak concepts. The server aggregates progress data per concept and per time window using a data-processing library. The server computes, for each concept, the ratio of correct answers, the distribution of answer times, and the number of attempts. The server compares these values against predetermined thresholds and statistical norms stored in configuration tables. For example, the server may classify a concept as a weak concept when the correct-answer ratio is below a first threshold and the median answer time is above a second threshold. The server writes the resulting comprehension index and weak-concept labels into a dedicated table linked to the learner identifier.

The server uses the comprehension index and weak concepts to generate prompt sentences that control problem-set construction. For example, when the server determines that a learner's achievement index for quadratic equations is below a threshold, the server generates a meta prompt such as:

“The learner is practicing quadratic equations and often makes mistakes in computing the discriminant. Generate one prompt sentence that encourages the learner to double-check b\hat{ }2-4ac before solving the next equation.”

The server then receives a text generation result, post-processes it into a single prompt sentence such as:

“In the next step, please double-check the value of b\hat{ }2-4ac carefully before you solve the quadratic equation.”

The server embeds this prompt sentence in a control message that instructs a content-selection module to include problems that emphasize discriminant calculation. In this manner, the prompt sentence does not merely serve as user-visible text but functions as an internal control primitive that parameterizes subsequent algorithmic steps. This design improves computational efficiency, because the server can reuse generic selection algorithms while varying their behavior through prompt sentences.

The server further uses the generative AI model to create individualized instructional messages. For example, after the learner has completed several basic factoring problems successfully, the server may generate a meta prompt:

“The learner has just completed three easy problems correctly and quickly. Generate one prompt sentence that invites the learner to try a more difficult problem on quadratic equations.”

The server receives a text generation result such as:

“You solved the previous three questions very quickly; now let's try a more challenging quadratic equation to deepen your understanding.”

The server supplies this prompt sentence to the terminal, which displays it above the next set of problems. Because the server uses encoded learner features and fixed meta-prompt templates, this process differs from simple template-based messaging and instead enables fine-grained, algorithmic adaptation of guidance content while still being executed under deterministic control of the server.

The server also estimates an emotional state of the learner using multimodal data. The terminal captures facial images using the camera, interaction patterns from the touch screen, and optionally biometric indicators from connected sensors. The terminal transmits extracted features, such as facial landmarks, expression labels, interaction timing statistics, and heart-rate values, to the server. The server performs feature fusion using a classifier model such as a shallow neural network or gradient-boosted tree model trained to output emotional states like “engaged,” “frustrated,” or “bored.” The server uses a loss function such as categorical cross-entropy during training. By processing fused features on the server side, the system achieves higher classification accuracy than systems that consider only single-modal data.

The server then uses the estimated emotional state as an additional input to the learning-story optimization logic and to the generation of prompt sentences.

For instance, when the server detects that the learner is “frustrated” and the comprehension index for a current concept is low, the server generates a meta prompt that explicitly requests a supportive style and reduced difficulty, such as:

“The learner is frustrated and has low accuracy on the current topic. Generate a short, supportive prompt sentence that suggests reviewing simpler examples before continuing.”

A corresponding prompt sentence might be:

“It seems this topic is a bit challenging; let's review a simpler example together before moving on.”

The server then instructs the learning-story module to insert review units before more advanced content, thereby directly linking emotional-state estimation with data-structure modification in the learning story.

The server also generates detailed explanation texts for terms and concepts. When the user taps a term on the terminal, the terminal sends term information and learning context information to the server. The server constructs a meta prompt including the subject, the current topic, and the term. For example, the server may generate:

“The learner is studying quadratic equations and asked about the term ‘discriminant’. Generate a concise explanation suitable for a high school student, including an example.” The server inputs this meta prompt to the generative AI model and receives a text generation result. The server applies post-processing such as enforcing a maximum sentence count, checking for prohibited content, and standardizing notation. The server then returns a detailed explanation text such as:

“The discriminant is the value b\hat{ }2-4ac in a quadratic equation ax\hat{ }2+bx+c=0. If the discriminant is positive, the equation has two real solutions; if it is zero, it has one real solution; if it is negative, it has no real solutions.”

The terminal displays this text in an overlay window. By integrating explanation generation into the same meta-prompt and post-processing framework, the server reduces storage space needed for static glossaries and improves flexibility, while still maintaining control over output quality through deterministic post-processing.

The server employs specific internal data structures and modular components to achieve technical advantages. The server separates the learning story, progress data, prompt templates, and generative outputs into distinct tables and in-memory caches. The server defines update rules such that only affected parts of the learning story graph are recomputed when new progress data arrives. This partial-update mechanism reduces unnecessary recomputation and database writes, which yields improved throughput and decreased latency compared with naive full recomputation. The server also caches frequently used meta-prompt templates and decomposes them into a fixed structure and variable fields populated from learner features. This reduces string-construction overhead and ensures that meta prompts remain within predictable length bounds, which leads to more efficient use of the generative AI model.

In one variation, the server uses an encoder network to transform learner state features (such as recent scores, time-on-task, and emotional state probabilities) into a lower-dimensional vector representation. The server then uses this representation to select among a library of meta-prompt patterns, choosing one that matches the learner's situation. This technique, which involves vector similarity search or nearest-neighbor lookup, allows the server to avoid exhaustive rule-based branching and leads to faster decision-making, particularly when the space of possible learner states is large.

In another variation, the server uses a reinforcement-learning algorithm to adjust parameters of the prompt-generation process, such as length and tone, based on observed learner reactions. The server models reward as improvement in comprehension indices and reduction in dropout events over time. The server stores policy parameters that determine how meta prompts are constructed. The server updates these parameters periodically using algorithms such as policy gradient or Q-learning. By doing so, the system not only reacts to current learner state but also optimizes its own behavior across many learners and sessions, which improves the overall effectiveness and efficiency of the computer system.

The terminal is configured to reduce communication overhead and improve responsiveness. The terminal aggregates multiple interaction events and answer records into batches before sending them to the server. The terminal applies compression or encoding to reduce payload size. The server acknowledges receipt and processes each batch as a unit, which decreases per-request overhead on the server's network stack and database transaction layer. The server may also instruct the terminal, via configuration messages, on how frequently to send progress data based on network conditions and server load, thereby dynamically balancing computation and communication costs.

The user interacts with the system through the terminal's user interface. The user selects courses, reads content, answers questions, and requests explanations. The user sees prompt sentences that guide the next actions, such as:

“In the next step, let's use the quadratic formula to solve x\hat{ }2+5x+6=0. First, identify the values of a, b, and c.” or

“You have mastered factoring simple quadratic equations. Now try solving a quadratic equation using the quadratic formula: 2x\hat{ }2−3x−2=0.”

The user's responses and subsequent behavior are continuously logged and fed back to the server's learning-story optimization and prompt-generation pipelines, thereby closing the control loop.

Because the server models the learning story as a modifiable data structure, uses meta prompts and generative AI outputs as internal control primitives, and fuses multimodal learner-state information into the adaptation logic, the system goes beyond mere automation of human teaching tasks. The server improves computational efficiency by reducing redundant recomputation and network traffic, improves accuracy by using structured feature sets and trained models for state estimation and text generation, and improves data management by maintaining separate but linked representations for curricula, progress, prompts, and emotional-state estimates. These features result in a technical improvement to the functioning of the computer system itself, in terms of speed, scalability, and precision of adaptation, rather than merely implementing a business or educational policy on a generic computer.

Various alternative embodiments may be used. The server may employ different neural-network architectures such as recurrent networks or convolutional sequence models. The server may store data in non-relational databases or in-memory data grids for higher throughput. The generative AI model may be deployed as a separate inference service accessed via remote procedure calls, with the server managing request queues and caching of frequent outputs. The emotional-state classifier may be implemented using classical machine-learning algorithms with hand-crafted features instead of deep learning. The server may implement different thresholds and scoring formulas for the comprehension index. Each of these variations adheres to the same core principle: the server treats prompt sentences and meta prompts as structured control signals that coordinate learning-story configuration, problem-set generation, and explanation generation in a technically optimized manner.

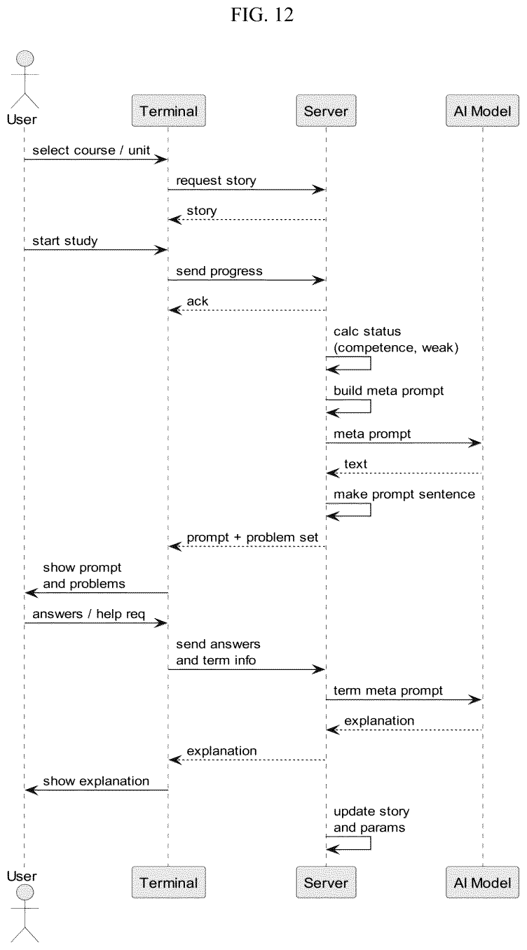

The following describes the processing flow using FIG. 12.

### Step 1:

The server acquires curriculum data as input from an educational-information storage unit and generates a template learning story as output. The server reads structured records (subjects, topics, lessons, prerequisites, difficulty tags) using database queries. The server converts rows into internal learning-unit objects, links units into a directed graph representing learning order and prerequisite relationships, and stores identifiers, metadata, and edges. Based on these objects, the server constructs a course-level template learning story and writes it back to the database as a serialized structure.

### Step 2:

The terminal receives the template learning story as input from the server and generates a rendered learning-path interface as output. The terminal sends a request containing course identifiers and user identifiers to the server. The terminal parses the returned JSON structure into a local state representation and maps each learning unit to visual components such as cards, lists, or timelines. The terminal displays unit titles, brief descriptions, and progress indicators, enabling the user to tap a unit to begin learning.

### Step 3:

The user provides interaction events as input to the terminal and generates learning actions and answer submissions as output. The user selects a learning unit from the displayed path, reads the content rendered on the screen, and operates UI elements such as “Next,” “Start Practice,” or “Show Explanation.” The user enters responses to problems using on-screen keyboards, multiple-choice buttons, or other input controls. These actions yield concrete data such as selected options, free-text answers, and navigation commands, which the terminal records as logs.

### Step 4:

The terminal records user interactions and answer information as input and generates progress data batches as output. The terminal timestamps each event, associates it with a unit identifier and a problem identifier, and computes elapsed answer time by subtracting start time from submission time. The terminal aggregates a sequence of events (answers, navigation, help requests) into a structured batch and serializes this batch as a compact payload. The terminal then transmits the payload to the server via a network connection.

### Step 5:

The server receives progress data batches as input and generates updated progress records as output. The server validates payload structure and user authentication, then parses answer contents, correctness flags (if locally computed), timestamps, and operation history. The server writes each event as a row in a progress table and updates indices keyed by user, unit, and concept identifiers. The server may also pre-compute basic aggregates, such as counts of answered problems per unit, and store them in summary tables to reduce the load of later queries.

### Step 6:

The server takes progress records as input and generates comprehension indices and weak-concept labels as output. The server reads all recent records for a given learner and groups them by concept, using query conditions on concept identifiers. The server calculates metrics such as correct-answer ratio, mean and median answer time, and number of attempts per concept. The server compares metrics against predefined thresholds and normative baselines and labels concepts whose metrics fall below target as weak concepts. The server writes comprehension indices and weak-concept flags into a dedicated learner-concept table.

### Step 7:

The server receives comprehension indices and weak-concept labels as input and produces problem-set definitions as output. The server formulates selection conditions that prioritize problems tagged with weak concepts, appropriate difficulty levels, and diverse problem formats. The server queries a problem bank for matching problems and assembles selected items into a problem-set object containing problem text, options, correct answers, and metadata. If insufficient items are available, the server triggers a generative AI model to create additional problem texts. The server stores the completed problem-set definition in the database and prepares it to be sent to the terminal.

### Step 8:

The terminal takes problem-set definitions as input and renders interactive problems as output. The terminal requests a problem set for the active learning unit, receives structured problem data from the server, and converts each item into on-screen components (question text areas, answer fields, radio buttons, explanation placeholders). The terminal orders problems according to the sequence specified by the server and initializes local state to track which questions have been viewed or answered. The terminal displays the first problem and updates the interface as the user navigates through the set.

### Step 9:

The user provides answers and requests for help as input to the terminal and generates new progress events as output. The user reads each problem, enters a response, and taps a submission control. The user may tap highlighted terms or a help icon to request explanations for unfamiliar terms or concepts. These operations create events that include problem identifiers, answer contents, correctness (if locally evaluated), and term-identification data, which the terminal logs and later transmits to the server.

### Step 10:

The server receives help requests containing term information and learning context as input and generates detailed explanation texts as output. The server constructs a meta prompt that includes the subject, topic, and target term, and specifies constraints such as length and intended level. The server inputs the meta prompt to the generative AI model, decodes the resulting token sequence into text, and applies post-processing (length trimming, prohibited-term filtering, notation standardization). The server outputs a final explanation text such as “The discriminant is the value b\hat{ }2-4ac in a quadratic equation ax\hat{ }2+bx+c=0,” and sends this text to the terminal.

### Step 11:

The terminal takes explanation texts as input and generates an augmented learning display as output. The terminal receives the explanation from the server, associates it with the originally tapped term, and displays it in a contextual UI element, such as a pop-up overlay or side panel. The terminal adjusts layout and scrolling behavior so that the main problem remains visible while the explanation is shown. The terminal logs that the user viewed the explanation, which becomes additional progress data for later analysis.

### Step 12:

The server accepts learner features and educational context as input and generates meta prompts for a generative AI model as output. The server composes a description of the learner's current state, including active unit, recent correctness, average answer time, and weak-concept list. The server embeds this description into a natural-language instruction that specifies the type of output required, such as “Generate one short, encouraging prompt sentence that suggests the next step and mentions the quadratic formula.” The server encodes this meta prompt into tokens and passes it to the generative AI model.

### Step 13:

The server receives raw text generation results from the generative AI model as input and produces standardized prompt sentences as output. The server decodes token sequences into text and evaluates the text according to internal rules (e.g., single-sentence constraint, maximum character count, allowed language). The server removes extraneous content, corrects minor formatting issues, and ensures that the text is a clear, actionable directive, such as “In the next step, let's use the quadratic formula to solve x\hat{ }2+5x+6=0. First, identify the values of a, b, and c.” The server stores this finalized prompt sentence and attaches it to the relevant learner and unit.

### Step 14:

The server takes standardized prompt sentences as input and generates control messages for content adjustment as output. The server maps prompt-sentence types (for example, “increase difficulty,” “insert review,” “focus on discriminant”) to algorithmic actions defined in internal configuration tables. The server creates a control object that encodes both the natural-language prompt for display and machine-readable flags that instruct the learning-story and problem-selection modules to modify order, amount, or difficulty of upcoming content. The server sends this combined control object and prompt sentence to the terminal.

### Step 15:

The terminal receives control messages containing prompt sentences as input and generates an updated guidance display as output. The terminal extracts the natural-language prompt sentence and displays it in a designated guidance area, such as a banner or message box. The terminal updates local configuration—for example, adjusting which problem set to request next or whether to open a review unit. The terminal then logs that a specific prompt sentence was shown, together with subsequent user actions, and includes this information in future progress-data batches.

### Step 16:

The user reads displayed prompt sentences as input and generates guided learning actions as output. The user interprets messages such as “You have mastered factoring simple quadratic equations. Now try solving a quadratic equation using the quadratic formula: 2x\hat{ }2−3x−2=0.” and chooses to follow the suggestion by starting the indicated problem or review content. The user's choices result in concrete navigation and answer events that reflect compliance or non-compliance with the prompts, and these events flow back to the server as part of the control loop.

### Step 17:

The server receives aggregated learner reactions and prompt-display logs as input and produces updated learning-story configurations as output. The server analyzes how often specific prompt sentences led to desired actions (such as starting a review unit or completing a harder problem) and correlates these with changes in comprehension indices. The server uses these correlations to adjust thresholds and selection rules for future prompt generation and story modification. The server writes updated parameters and modified subgraphs of the learning story into the database, yielding a more optimized learning path for subsequent sessions.

### Step 18:

The server accepts emotional-state estimates and updated progress metrics as input and generates revised scheduling and difficulty decisions as output. The server combines recent emotional-state classifications (e.g., engaged, frustrated) with performance metrics to select one of several adaptation strategies, such as slowing the pace, inserting review, or raising challenge. The server then modifies the upcoming sequence of learning units and problem sets in the learning-story graph, marking some nodes as deferred and others as prioritized. The server stores these modifications and notifies the terminal so that subsequent content requests retrieve the revised path.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented education support systems typically provide static problem sets and fixed learning materials that are only coarsely aligned with a learner's curriculum and declared proficiency level. Even when such systems record scores and simple completion flags, the recorded data is often used in a limited way, for example, merely to unlock the next unit or to adjust a global difficulty setting. As a result, conventional systems do not fully exploit the available learning progress information to generate finely tuned problem sets, nor do they dynamically close the loop between detailed learner performance data and subsequent content generation.

From a computer technology standpoint, existing systems inadequately integrate generative AI models into the core of the learning pipeline. Generative AI models are often called with manually written prompts, without systematic generation, storage, and reuse of machine-understandable learning state. The lack of a structured mechanism to (i) analyze granular learning progress, (ii) automatically construct precise prompt sentences for a generative AI model, (iii) parse and structure the generated problem texts, and (iv) feed back high-resolution performance metrics into the next round of prompt generation, leads to several technical problems: increased manual configuration burden, inconsistent content quality, inefficient use of computational resources, and difficulty in maintaining traceable, data-driven adaptation logic within the server.

Moreover, existing systems generally treat learner errors at the level of entire questions rather than at the level of specific terms or concepts. As a consequence, a server cannot automatically identify which terms or concepts are persistently misunderstood, and cannot automatically trigger targeted generation of explanatory texts for those terms. This limitation results in suboptimal use of natural language processing capabilities and generative AI models, because the server remains largely a passive conduit that displays generated text rather than an active computing entity that orchestrates fine-grained analysis, targeted prompt construction, and structured delivery of generated outputs.

In addition, conventional architectures do not provide a robust, iterative feedback loop in which detailed performance statistics (such as correctness rate, answer time, and error patterns per learning domain) are continuously stored and re-used as machine-readable learning progress information that directly governs the next-generation prompt sentences. Without such a loop, the server cannot evolve the generated content in a stable and predictable way, and cannot maintain explainability or reproducibility of how problem sets are tailored for each learner. This lack of closed-loop orchestration between data collection, data analysis, prompt sentence generation, generative AI invocation, and structured result integration constitutes a technical shortcoming in the design and operation of computer-based adaptive learning systems.

Accordingly, there is a need for a computer-implemented system and method that improves the underlying server-side technology by: (i) systematically collecting and representing learning progress information, (ii) analytically determining weak domains and priority learning domains, (iii) automatically generating structured prompt sentences as generation instructions for a generative AI model, (iv) receiving and structurally organizing generated problem texts, and (v) iteratively updating the learning progress information based on grading and statistical analysis. There is also a need for the server to automatically detect misunderstood terms or concepts and to generate, via targeted prompt sentences, detailed explanatory texts that can be provided to the learner in a structured, on-demand fashion. By addressing these needs, the invention improves the functioning of the server as a computing platform that orchestrates data processing, prompt generation, model interaction, and adaptive content delivery in a technically robust and scalable manner.

The specific processing by the specific processing unit 290 of the data processing device 12 in Example 2 is realized by the following means.

The present invention provides a server comprising a processor and a memory storing instructions which, when executed by the processor, cause the processor to store learner-related history information and evaluation information as learning progress information in a storage unit; analyze the learning progress information including learning history, evaluation results, learning time, and achievement level for each learning domain, and determine a weak domain and a priority learning domain for a learner; generate, on the basis of the determined learning domain, a number of problems, a difficulty level, a problem type, and an output distribution, a prompt sentence described in a natural language as generation instruction information for a generative AI model; transmit, via a communication network, the prompt sentence to the generative AI model disposed externally or internally to the server, and receive, from the generative AI model, a group of problem texts generated in response to the prompt sentence; parse and format the group of problem texts in accordance with a predefined rule, assign problem identification information, domain information, and difficulty information to each problem text, structure the problem texts as problem set data, and store the structured problem set data in association with the learning progress information in the storage unit; convert the problem set data into a transmission format corresponding to a user terminal, transmit the converted problem set data to the user terminal, and receive answer information and learning behavior information from the user terminal; execute grading processing and statistical processing on the basis of the answer information, calculate, for each learning domain, a correctness rate, an answer time, and an error tendency, and update the learning progress information so that subsequent prompt sentences are generated iteratively in accordance with the updated learning progress information; generate, on the basis of a weak domain determined from the learning progress information and on the basis of problem set generation history, a prompt sentence that specifies a problem type, a question format, and explanation generation conditions for reinforcing the weak domain, and transmit the prompt sentence to the generative AI model and receive, from the generative AI model, a group of problem texts for weak-domain reinforcement and automatically construct, from the group of problem texts for weak-domain reinforcement, a new problem set as the problem set data; and identify, from the answer information and the learning behavior information, a term or concept on which incorrect answers are concentrated, generate a prompt sentence that instructs the generative AI model to generate an explanatory text including a meaning explanation, an intuitive analogy, an example, and stepwise explanation steps for the identified term or concept, transmit the prompt sentence to the generative AI model, receive, from the generative AI model, a detailed explanatory text generated by a natural language processing technique, and provide the detailed explanatory text as explanation information to the learner via the user terminal. This enables the server to operate as an improved computing platform that automatically orchestrates learning progress analysis, iterative prompt sentence generation, structured interaction with a generative AI model, and adaptive delivery of problem sets and explanatory texts, thereby enhancing the technical efficiency, scalability, and precision of computer-implemented personalized learning.

The term “learning progress information” refers to machine-readable data representing a learner's state of advancement in one or more learning domains, including at least learning history, evaluation results, learning time, and achievement level per domain.

The term “learning history” refers to chronological information indicating which learning materials, subjects, or domains a learner has studied, and when and how often such study activities have occurred.

The term “evaluation results” refers to assessment data derived from learner responses, including scores, correctness indicators, pass/fail flags, and other quantitative or qualitative measures of learner performance.

The term “learning time” refers to time-related data indicating durations or timestamps associated with learner activities, including time spent on individual problems, sessions, or learning domains.

The term “achievement level” refers to a computed or assigned indicator of a learner's proficiency in a learning domain, derived from evaluation results, learning time, and other performance metrics.

The term “learning domain” refers to a classification unit of learning content, such as a subject, topic, chapter, or concept category, used to organize learning progress information and problem sets.

The term “weak domain” refers to a learning domain that is determined, on the basis of learning progress information, to exhibit insufficient learner proficiency according to a predetermined criterion.

The term “priority learning domain” refers to a learning domain that is designated, based on analysis of learning progress information, as a higher-priority target for subsequent learning or practice.

The term “prompt sentence” refers to a text string expressed in a natural language that encodes generation instruction information for a generative AI model, including specifications such as target domain, number of problems, difficulty level, problem type, and output constraints.

The term “generation instruction information” refers to structured or semi-structured information contained in or represented by a prompt sentence that directs a generative AI model to generate specific output, such as problems or explanatory text.

The term “generative AI model” refers to a machine learning model configured to generate new content, including natural language text, in response to input data such as a prompt sentence, using techniques such as neural networks and probabilistic token generation.

The term “group of problem texts” refers to a plurality of problem statements or questions generated by a generative AI model in response to a prompt sentence.

The term “problem identification information” refers to data that uniquely identifies each problem within a problem set or database, such as a problem ID or problem key.

The term “domain information” refers to data indicating the learning domain or category associated with a problem, such as a topic label or subject code.

The term “difficulty information” refers to data indicating a difficulty level assigned to a problem, such as basic, intermediate, advanced, or a numerical difficulty score.

The term “problem set data” refers to structured data representing a collection of one or more problems, including problem texts and associated metadata such as identification information, domain information, and difficulty information.

The term “user terminal” refers to an electronic device operated by a learner, such as a personal computer, smartphone, or tablet, that communicates with the server to send and receive learning-related data.

The term “answer information” refers to data representing learner responses to problems, including the content of answers, selected options, input values, and submission status.

The term “learning behavior information” refers to data describing how a learner interacts with learning content, including navigation patterns, time spent per problem, frequency of access, and interaction events.

The term “grading processing” refers to computational operations that determine the correctness or score of learner answers by comparing them with reference criteria or by using an automated evaluation procedure.

The term “statistical processing” refers to computational operations that aggregate and analyze answer information and learning behavior information to derive metrics such as correctness rate, average answer time, and error patterns.

The term “correctness rate” refers to a numerical metric indicating the proportion of correct answers within a set of problems, calculated for a learner, a domain, or a problem set.

The term “answer time” refers to a time interval or duration associated with answering a problem, typically measured from the display of a problem to the submission of an answer.

The term “error tendency” refers to a pattern or characteristic of incorrect answers, such as recurring mistake types, frequently misunderstood concepts, or systematic biases in learner responses.

The term “problem set generation history” refers to stored data indicating past generation and delivery of problem sets to a learner, including information such as topics, problem counts, difficulties, and timestamps.

The term “problem type” refers to a classification of problems according to format or cognitive requirement, such as multiple-choice, short answer, calculation, conceptual, or explanation-type questions.

The term “question format” refers to structural attributes of a problem presentation, including layout, input method, and response structure expected from the learner.

The term “explanation generation conditions” refers to parameters or constraints included in a prompt sentence that specify how a generative AI model should generate explanatory text, such as target audience level, length, style, and inclusion of examples.

The term “term or concept” refers to a unit of meaning, such as a technical term, definition, principle, or abstract idea, that appears in learning content or problems.

The term “explanatory text” refers to natural language text that explains a term or concept, including descriptions, analogies, examples, and stepwise reasoning.

The term “natural language processing technique” refers to a computational technique for analyzing, understanding, or generating human language, used by a generative AI model to produce problem texts or explanatory texts.

The term “storage unit” refers to a hardware or logical component, such as a memory device or database, configured to store learning progress information, problem set data, and related information.

The term “communication network” refers to a wired or wireless network infrastructure that enables data transmission between the server, the generative AI model (if remote), and user terminals.

The term “server” refers to a computing apparatus including at least one processor and memory, configured to execute instructions for storing, analyzing, generating, transmitting, and receiving data in connection with learning support functions.

The term “processor” refers to one or more hardware processing units, such as a central processing unit or other execution circuitry, configured to execute instructions and perform data processing operations.

The term “memory” refers to a non-transitory computer-readable storage medium configured to store executable instructions and data used by the processor.

In one embodiment, a server implements the invention by executing a program stored in a non-transitory computer-readable medium. The server includes at least one processor, a main memory, a network interface, and a storage unit. The server executes an application program on an operating system such as a server-class operating system. The server uses a database management system such as a relational database engine (for example, PostgreSQL or MySQL) as the storage unit, and uses a web application framework (for example, a Python framework or a Java framework) as an execution environment for application logic. The server also uses an HTTP client library to communicate with an external or internal generative AI model over a communication network.

The server stores learning progress information in the storage unit. The learning progress information is represented as structured records in database tables. In one example, the server maintains a table for learners, a table for learning domains, a table for problem sets, a table for individual problems, a table for learner answers, and a table for explanation texts. Each record in the learning progress information includes fields such as a learner identifier, a domain identifier, a cumulative score, a number of attempts, an average correctness rate, total learning time, difficulty level history, and timestamps.

The server uses an internal data structure, such as an in-memory object, to represent a learning profile for each learner. The learning profile aggregates multiple rows from the learning progress information tables and includes, for each learning domain, the computed correctness rate, the distribution of problem types answered, and an error tendency indicator derived from previous answers. The server uses numerical operations performed by the processor to update these aggregated values when new answer information is received. The server analyzes the learning progress information to determine a weak domain and a priority learning domain for each learner. The server performs this analysis by executing a domain analysis algorithm. For example, the server computes a weighted score for each learning domain based on correctness rate, number of attempts, and recency of interaction.

The server assigns higher weights to recent answers and lower weights to older answers. The server then compares the weighted score to a threshold and identifies any domain whose weighted score is below the threshold as a weak domain. The server also determines a priority learning domain by selecting a weak domain that has not been recently targeted by a problem set, using data from the problem set generation history.

The server generates a prompt sentence as generation instruction information for a generative AI model. The server uses a prompt generation module, implemented as a software component, to create the prompt sentence. The server loads a prompt template from a configuration file. The template includes placeholders for a learning domain name, a number of problems, a difficulty level, a ratio of conceptual to calculation problems, and constraints on output format. The server replaces these placeholders with actual values computed from the learning profile.

For example, when the learning profile indicates that a learner has studied the Fundamental Theorem of Calculus but shows a correctness rate of 60% on related problems, the server generates the following prompt sentence:

“The student has studied the Fundamental Theorem of Calculus and still makes frequent mistakes when applying the theorem to definite integrals. Please generate 8 practice problems related to the Fundamental Theorem of Calculus.
Include 4 conceptual questions that test understanding of the meaning and implications of the theorem.
Include 4 calculation problems that require evaluating definite integrals using the theorem.
Use clear and concise wording suitable for a first-year university student.
Provide only the problem statements without solutions, and number the questions from 1 to 8.”

The server transmits the prompt sentence to a generative AI model using the network interface. In one embodiment, the generative AI model is provided as a transformer-based neural network deployed on a separate computing system. The generative AI model is configured with multiple self-attention layers, feed-forward layers, and layer normalization components, and the model parameters are stored as weight matrices. The generative AI model receives the prompt sentence as a sequence of tokens, applies tokenization according to a predefined vocabulary, and processes the token sequence through the transformer layers to compute a probability distribution over the vocabulary for each next token. The generative AI model then selects or samples tokens according to decoding parameters such as temperature, top-k, or top-p, thereby generating a continuous text output that includes a group of problem texts.

The server receives the generated text as an HTTP response and stores the raw text in the storage unit for traceability. The server then invokes a parsing module that splits the generated text into individual problem texts based on numbering or delimiter patterns, such as lines beginning with “1.”, “2.”, and so on. The server trims unnecessary whitespace, normalizes line breaks, and checks that the number of extracted problems matches the expected number indicated in the prompt sentence. If there is a mismatch, the server may apply a rule-based correction or may discard the output and regenerate a new prompt sentence with adjusted parameters to reduce parsing ambiguity.

The server constructs problem set data by assigning problem identification information, domain information, and difficulty information to each problem text. The server maps each problem text to a learning domain using either an explicit domain label requested in the prompt sentence or a predefined mapping based on the target domain. The server stores the structured problem set data in the database as rows in problem and problem set tables, including fields for text, domain, difficulty, problem type, and origin model version. The server associates the problem set with a specific learner by storing a learner identifier together with the problem set identifier.

The server converts the problem set data into a transmission format suitable for a user terminal. When the user terminal is a web browser, the server formats the problem set as a structured document such as HTML with embedded identifiers. When the user terminal is a mobile application, the server serializes the problem set data as a JSON-like structure and sends it over a secure network protocol such as HTTPS. The server includes in the transmitted data the problem texts, problem identifiers, and any metadata required to render the problems and to record answers.

The terminal receives the problem set data from the server. The terminal operates as a client device, such as a smartphone, tablet, or personal computer, executing a client program or browser. The terminal parses the received data and displays the problems via a graphical user interface. The terminal uses visual components such as text views and input fields to render each problem. The terminal also displays navigation controls so that the user can move between questions.

The user interacts with the terminal to read each problem, think about the answer, and input the answer into the designated input fields. The user may enter numeric answers, textual explanations, or selected choices for multiple-choice questions. After completing a problem or a set of problems, the user triggers submission through a user interface control. The terminal packages the answer information along with timestamps, problem identifiers, and device information, and sends this package to the server over the network.

The server processes the answer information using a grading module. In one embodiment, the server compares the user's answers with reference answers stored in the database. For calculation problems, the server may evaluate mathematical expressions, perform numerical comparisons within a tolerance, and determine correctness. For conceptual or open-ended questions, the server may generate a grading-oriented prompt sentence to the generative AI model, such as:
“You are evaluating a student's answer.
Question: [problem text].
Student's answer: [student answer].
Please output either ‘correct’ or ‘incorrect’ and provide a brief justification in one or two sentences.”

The server injects the problem text and the student answer into the prompt sentence and sends it to the generative AI model. The generative AI model applies the same transformer architecture to generate a classification and an explanation. The server parses the model's output, extracts a correctness label, and stores the result in the answer table. The server also records auxiliary information such as the model's confidence if provided, or the length of the justification.

The server performs statistical processing on the collected answer information. The server calculates, for each learning domain, the correctness rate by dividing the number of correct answers by the total number of answers. The server calculates an average answer time by computing the difference between the problem display time and the answer submission time. The server identifies error tendencies by analyzing patterns such as recurrent wrong options selected in multiple-choice problems or repeated misinterpretation of a specific mathematical symbol. The server may implement a feature extraction algorithm that maps each problem to concept tags and then accumulates incorrect counts per concept tag to identify problematic concepts.

The server updates the learning progress information with these computed statistics. The server replaces or increments the cumulative correctness rate, learning time, and other metrics stored for each learning domain. The server then recalculates the weak domains and priority learning domains based on the updated statistics, thereby completing one cycle of the feedback loop. Because this update is performed using structured metrics and domain-specific thresholds, the server continuously adapts the problem generation behavior in a reproducible way.

The server also identifies specific terms or concepts that are frequently misunderstood. To achieve this, the server maintains a mapping between problem texts and concept identifiers. When the correctness rate for problems associated with a particular concept falls below a predetermined threshold, the server flags that concept as problematic. The server then generates an explanation-oriented prompt sentence for the generative AI model, such as: “The student is having difficulty understanding the concept of a definite integral in the context of the Fundamental Theorem of Calculus. Please provide a detailed explanation of the concept of a definite integral, including:
A clear definition in simple language,
An intuitive analogy such as area under a curve,
One numerical example with step-by-step explanation,
Avoiding advanced topics beyond introductory calculus.”

The server sends this prompt sentence to the generative AI model and receives an explanatory text as the output. The server stores the explanatory text in the explanation table together with the concept identifier and the learner identifier. The server then transmits this explanatory text to the terminal when the terminal requests help for that concept or when the server detects that the learner repeatedly fails problems involving that concept.

The terminal displays the explanatory text to the user in association with the corresponding term or concept. For example, the terminal may highlight the term “definite integral” in the problem text and present a popup window containing the generated explanation when the user selects the term. The user can then read the explanation and attempt related problems with improved understanding.

From a technical standpoint, the described server implementation improves computer technology beyond merely automating human teaching. The server uses specific data structures for learning progress information, such as normalized tables and in-memory profile objects, to enable efficient aggregation and incremental updates. These data structures allow the server to compute domain-level statistics without scanning all historical data each time, reducing computational load and improving response time.

The server also uses non-conventional prompt generation and parsing logic that is tightly coupled with these data structures. Instead of having a human manually craft prompts, the server algorithmically constructs prompt sentences based on numerical metrics, domain thresholds, and problem set generation history. This construction reduces variability and makes it possible to systematically control the generative AI model. The server applies a defined parsing algorithm to the generated text, with checks for consistency and fallback strategies, thereby converting unstructured AI output into structured problem set data with predictable schema. This transformation is not a generic text display, but a specific technical process that enables database storage, indexing, and retrieval of problems for efficient reuse and analysis.

The generative AI model itself is implemented as a multi-layer transformer neural network. During training, the model receives sequences of tokens derived from text corpora, and the model parameters are optimized using a loss function such as cross-entropy loss. The training process uses gradient-based optimization algorithms, such as stochastic gradient descent with adaptive learning rate methods, to update weight matrices in the attention and feed-forward layers. During inference in the described system, the server controls the model's behavior by setting decoding parameters and by constructing prompt sentences with explicit instructions. This control leads to more stable and relevant outputs compared to naive use of the model. The server's integrated use of learning progress information, prompt sentence generation, generative AI output structuring, and statistical feedback creates a closed technical loop that reduces the amount of unnecessary network traffic and computational waste. Because the server focuses generation on specific weak domains and limits the number and type of problems according to computed parameters, the system avoids generating broad or irrelevant content, thereby reducing response size and the number of model calls. The discrete representation of problem set generation history allows the server to avoid repeated generation of similar content, further reducing computational overhead.

In addition, the server improves accuracy and reliability in assessing learner performance and in targeting explanations. By tying problem texts, domains, and concepts to specific database identifiers and tracking error tendencies per concept, the server can localize misunderstandings at a finer granularity than a human instructor typically can without extensive manual data processing. The combination of concept-tagged problems, concept-level error counters, and explanation-specific prompt sentences allows the server to generate targeted explanatory texts only where needed, preventing unnecessary or redundant explanations and improving bandwidth usage and user interface clarity.

In an alternative embodiment, the generative AI model is deployed on the same hardware as the server, using a graphics processing unit. The server then calls the model via an internal API and can adjust the model configuration at runtime, such as switching between different model sizes according to server load. This variation improves end-to-end latency and allows the server to apply load balancing strategies that are not available when relying only on external services.

In another embodiment, the server maintains multiple prompt templates for different learner types or device types. For example, the server uses a concise prompt template for low-bandwidth mobile terminals and a more detailed prompt template for high-performance devices. The server selects the appropriate template based on device information received from the terminal. This adaptation helps reduce communication load and ensures that the generated content is suited to the capabilities of the user terminal, providing an additional technical improvement at the networking and rendering layers.

The described system thus provides a specific arrangement of hardware and software components in which the server, terminal, and user interact through structured data flows, targeted prompt sentences, and generative AI model outputs. The server performs non-conventional, domain-specific processing to analyze learning progress information, construct and refine prompt sentences, and convert unstructured generated text into structured, reusable educational data. Because of these technical arrangements, the system achieves improvements in processing speed, accuracy of adaptation, storage efficiency, and communication efficiency, thereby improving the functioning of the computer system as a whole.

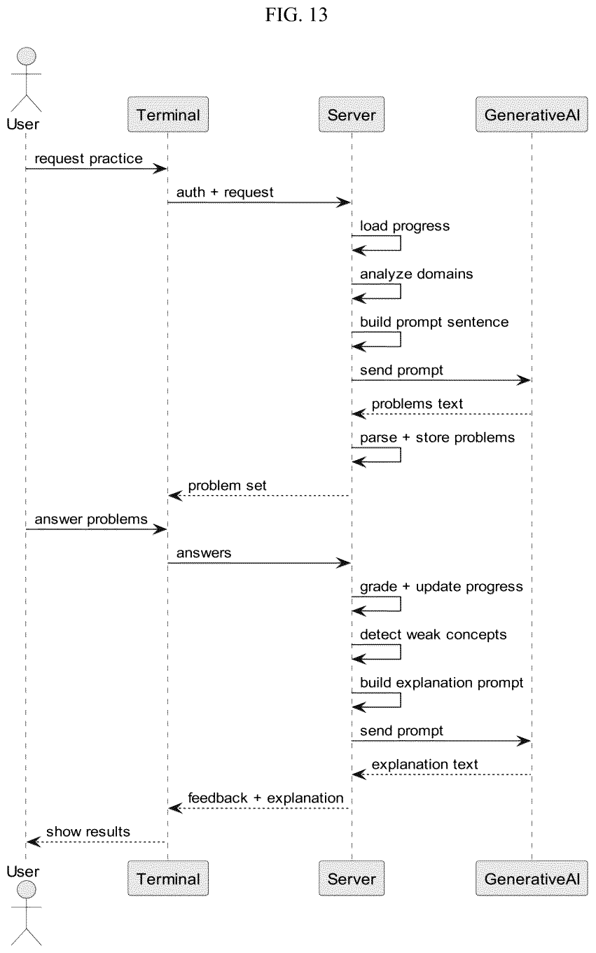

The following describes the processing flow using FIG. 13.

### Step 1:

Server initializes system resources and configurations.

Server loads configuration data as input, including database connection parameters, generative AI model endpoint URLs, authentication keys, and prompt templates stored in configuration files. Server processes this input by parsing the configuration files, validating parameter formats, and storing the resulting values in in-memory configuration objects. Server establishes output by creating active connections to the database engine and preparing an HTTP client instance for later communication with the generative AI model.

### Step 2:

Server authenticates the user and identifies the terminal.

Server receives, as input, a request from the terminal containing a session token, learner identifier, and device information such as device type and application version. Server verifies the session token using an authentication algorithm, checks device compatibility, and associates the learner identifier with a current session object. Server outputs an authenticated session record that is used as a key for subsequent retrieval and storage of learning progress information.

### Step 3:

Server retrieves learning progress information from the storage unit.

Server receives, as input, the authenticated learner identifier and an optional requested learning domain from the terminal request. Server executes database queries against learning progress tables to retrieve rows containing evaluation results, learning history, learning time, and previous problem set generation history. Server processes these rows by converting them into internal learning profile objects, aggregating scores and computing intermediate values such as total attempts and cumulative time. Server outputs a learning profile for the learner, structured per learning domain.

### Step 4:

Server analyzes the learning profile to determine weak and priority learning domains. Server receives, as input, the learning profile object containing correctness rates, attempt counts, and timestamps. Server performs numerical operations by computing a weighted score per learning domain, applying higher weights to recent results and lower weights to older data. Server compares each weighted score against predefined threshold values to classify domains as strong or weak. Server also examines problem set generation history to avoid repeatedly selecting the same domain. Server outputs at least one weak domain and one priority learning domain as analysis results.

### Step 5:

Server decides generation parameters for the next problem set.

Server receives, as input, the identified weak domain and priority learning domain along with learner-level settings such as preferred session length or difficulty preference. Server calculates the number of problems, difficulty distribution, and ratio of conceptual to calculation problems using heuristic rules or preconfigured policies. For example, server increases the number of problems for a domain with very low correctness rate and reduces it for a domain with moderately low correctness. Server outputs a generation parameter set that includes domain name, number of problems, difficulty level, and problem type allocation.

### Step 6:

Server constructs a detailed prompt sentence for the generative AI model.

Server receives, as input, the generation parameter set and a prompt template. Server performs string processing to replace placeholders in the template with actual values such as the learning domain name, problem counts, difficulty level, and formatting instructions. Server may concatenate additional constraints, for example, “Do not include solutions” or “Number the questions from 1 to N.” Server outputs a completed prompt sentence in natural language that encapsulates generation instruction information for the generative AI model.

### Step 7:

Server transmits the prompt sentence to the generative AI model and receives a group of problem texts.

Server receives, as input, the completed prompt sentence and model communication parameters such as model name and decoding settings. Server constructs an HTTP request payload including the prompt sentence and sends it via a communication network to the generative AI model endpoint. The generative AI model processes the prompt sentence internally and returns a generated text response. Server parses the HTTP response, extracts the generated text string, and outputs a raw generated text that contains a group of problem texts.

### Step 8:

Server parses and structures the generated problem texts.

Server receives, as input, the raw generated text from the generative AI model. Server applies a parsing algorithm that splits the text into individual problem candidates using delimiters such as numbered prefixes (“1.”, “2.”, etc.) or line breaks. Server removes extraneous characters, trims whitespace, and checks whether the number of extracted problem texts matches the requested number in the generation parameter set. If the count mismatches, server may perform corrective operations such as merging or discarding malformed segments. Server outputs a list of cleaned problem texts ready for registration.

### Step 9:

Server assigns metadata and stores problem set data in the storage unit.

Server receives, as input, the list of cleaned problem texts, the generation parameter set, and the learner identifier. Server generates unique problem identifiers and a problem set identifier using sequence generators or UUID algorithms. Server associates each problem text with the target learning domain, difficulty level, and problem type according to the generation parameters. Server writes this structured information into problem and problem set tables in the database. Server outputs stored problem set data, including identifiers and metadata, that can be referenced by subsequent processes and by the terminal.

### Step 10:

Server prepares and transmits the problem set to the terminal.

Server receives, as input, the stored problem set data and the terminal type information. Server converts the problem set data into a terminal-specific format, such as an HTML document for a browser or a structured JSON-like payload for a mobile application. Server may compress the payload to reduce network load. Server sends the formatted problem set over a secure protocol to the terminal. Server outputs a transmission confirmation and updates a delivery record indicating that the particular problem set has been assigned to the learner.

### Step 11:

Terminal receives and renders the problem set for the user.

Terminal receives, as input, the formatted problem set payload from the server. Terminal parses the payload according to its structure, extracting problem texts, identifiers, and associated metadata. Terminal maps these elements to graphical user interface components, such as text views for problem statements and input fields or selection controls for answers. Terminal outputs a rendered set of interactive problem screens that the user can view and manipulate.

### Step 12:

User solves problems and submits answers through the terminal.

User receives, as input, the displayed problem statements and any supplementary information shown by the terminal. User performs mental or written calculations, reasons about each question, and enters answers into the provided input elements. User initiates submission by activating a control such as a “Submit” button. User outputs answer content that is captured by the terminal as answer data associated with problem identifiers.

### Step 13:

Terminal collects answer information and sends it to the server.

Terminal receives, as input, the user's entered answers, timestamps of display and submission, and problem identifiers embedded in the interface. Terminal aggregates these values into an answer information payload that includes for each problem an identifier, the answer content, and time-related data. Terminal encodes this payload into a network message and transmits it to the server via a secure protocol. Terminal outputs a transmission status and may display a waiting or confirmation screen to the user.

### Step 14:

Server evaluates answers and updates learning progress information.

Server receives, as input, the answer information payload from the terminal and the corresponding problem set data from the database. Server compares each learner answer with reference criteria. For objective questions, server directly matches the learner answer against stored correct answers or evaluates expressions numerically. For subjective questions, server may generate and send a grading-oriented prompt sentence to the generative AI model that embeds the question and the learner answer, then receives and parses the model's classification of correctness. Server computes correctness flags, scores, and answer times for each problem and aggregates these values per learning domain. Server updates the learning progress information tables with new correctness rates, cumulative learning time, and error patterns. Server outputs an updated learning profile reflecting the learner's current state.

### Step 15:

Server identifies problematic concepts and generates explanatory prompt sentences. Server receives, as input, the updated learning profile and detailed answer records linked to concept tags. Server calculates error frequencies per concept by summing incorrect attempts associated with each concept identifier. Server identifies any concept whose incorrect count exceeds a threshold as a problematic concept. For each such concept, server constructs an explanation-oriented prompt sentence that includes the concept name, difficulty level of the learner, and requested explanation structure such as definition, analogy, and example. Server outputs a set of explanation prompt sentences targeted at specific problematic concepts.

### Step 16:

Server obtains explanatory texts from the generative AI model and stores them. Server receives, as input, the explanation prompt sentences. Server sends each prompt sentence to the generative AI model via the established network connection and receives generated explanatory texts in response. Server processes the generated texts by trimming and checking for language and relevance, and associates each text with its corresponding concept identifier and learner identifier. Server stores these explanatory texts in an explanations table in the database. Server outputs stored explanation records that can be retrieved on demand by the terminal.

### Step 17:

Server prepares feedback and explanation data and sends them to the terminal.

Server receives, as input, the updated learning profile, per-problem grading results, and stored explanation records related to problematic concepts. Server compiles a feedback package that includes correctness indicators, scores, per-domain performance summaries, and links or identifiers for available explanatory texts. Server formats this package according to the terminal type and compresses it if necessary. Server transmits the feedback package to the terminal using a secure communication channel. Server outputs a record that the feedback and explanations have been delivered for a specific problem set.

### Step 18:

Terminal displays feedback and explanatory texts to the user.

Terminal receives, as input, the feedback package from the server. Terminal parses the content and maps correctness indicators and scores to the corresponding problems in the user interface. Terminal highlights incorrect answers and presents buttons or interactive elements that allow the user to open explanatory texts linked to particular terms or concepts. When the user selects a highlighted term, terminal displays the associated explanatory text in a popup window or dedicated screen. Terminal outputs updated display states that reflect both performance feedback and targeted explanations.

### Step 19:

User reviews feedback and explanations and decides on further learning actions.

User receives, as input, the displayed feedback, scores, and explanatory texts. User reads the explanations, compares them with previous understanding, and may decide to attempt additional practice on weak domains or to review prior learning materials. User may instruct the terminal to request a new problem set or to open a different learning module. User outputs new interaction requests that, when received by the terminal and forwarded to the server, initiate another cycle starting from the retrieval and analysis of learning progress information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems typically deliver static or only coarsely adaptive learning content. In many architectures, a server selects questions from a fixed content repository based on simple rules such as overall score or completed units, and then sends the same or slightly reordered problem sets to different learners. Such systems do not leverage rich per-learner data, such as fine-grained answer histories, time-series learning progress, or real-time affective states, in a way that systematically changes the behavior of the content-generation algorithms themselves. As a result, the internal operation of these systems is largely insensitive to the individual user's evolving cognitive state and emotional context, and the computer technology is used only as a static delivery channel rather than as an adaptive content-generation engine.

Furthermore, even where machine learning or a generative AI model is used, existing systems often treat the generative AI model as a black box that is manually prompted by a human designer or that receives fixed, hard-coded instructions. The server logic does not automatically synthesize prompt sentences from structured learning data and emotion data, nor does it maintain a machine-readable history of prompt sentences and corresponding generation results for subsequent optimization. Consequently, the computing system does not improve its own content-generation behavior over time and cannot systematically refine how it interacts with the generative AI model based on accumulated learner interaction data. In addition, known systems that attempt to personalize learning based on learner performance rarely combine multiple heterogeneous data streams-such as curriculum structure, detailed answer-level performance metrics, explanation-request frequencies, and emotion signals from imaging and audio devices-into a unified prompt-generation and content-adjustment pipeline. Emotion recognition, if present at all, is often used only to change superficial user interface elements rather than to directly control how learning stories and problem sets are generated or adjusted at the model-input level. This causes the computational resources of the server and the generative AI model to be underutilized, and limits the technical effect on latency, content relevance, and system-level adaptability.

There is therefore a need for a computer-implemented learning system in which a processor automatically (i) generates structured prompt sentences for a generative AI model based on curriculum data, learning history, answer-level performance, and emotion signals; (ii) uses those prompt sentences to cause dynamic generation and adjustment of learning stories, problem sets, and explanations; and (iii) logs and reuses the associations between prompt sentences and generated outputs to iteratively refine the prompt-generation logic. By tightly coupling prompt-sentence generation, generative AI model invocation, and real-time adaptation based on emotional state and performance metrics, such a system can improve the functioning of the computer itself as a learning-content generation and orchestration engine, rather than merely automating manual authoring.

The specific processing by the specific processing unit 290 of the data processing device 12 in Application Example 2 is realized by the following means.

The present invention provides a server comprising a processor configured to acquire, from a storage unit, learning unit information and learning history information based on an educational plan, to generate a learning-story-generation prompt sentence and to input the learning-story-generation prompt sentence to a generative AI model so as to cause the generative AI model to output learning story information; to analyze learner-specific learning history information and answer result information to calculate a progress index and a weakness index, to generate a problem-set-generation prompt sentence including problem-set generation conditions based on the progress index and the weakness index, and to input the problem-set-generation prompt sentence to the generative AI model so as to cause the generative AI model to output problem group information, the processor further being configured to construct the problem group information as a problem set and to provide the problem set to a learner terminal; to obtain image information and audio information from at least one capture device, to calculate an emotional state of a learner over time by using an emotion estimation model, to generate an adjustment prompt sentence including adjustment conditions for changing at least one of difficulty, number of questions, amount of explanation, and presentation order of the learning story information and the problem group information based on the emotional state, the progress index, and the weakness index, and to input the adjustment prompt sentence to the generative AI model so as to cause the generative AI model to output adjusted learning content information, the processor further being configured to dynamically update contents of the learning story and the problem set based on the adjusted learning content information; and to associate and store, in the storage unit, each of the learning-story-generation prompt sentence, the problem-set-generation prompt sentence, and the adjustment prompt sentence with generation result information output from the generative AI model in response thereto, and to update generation conditions for subsequent prompt sentences based on the association. This enables the computer system to automatically synthesize and refine prompt sentences for the generative AI model from multi-modal learner data, to generate and adapt learning stories, problem sets, and detailed explanations in real time according to performance and emotional state, and to improve the internal operation and efficiency of the learning-content generation pipeline through iterative reuse of stored prompt-and-response associations.

The term “processor” refers to a hardware or virtual computation unit, such as a central processing unit or a processing core, that executes instructions to perform data acquisition, analysis, prompt-sentence generation, model invocation, and content update operations described in the system.

The term “storage unit” refers to a hardware or virtual data storage resource, such as a memory device or a database system, that stores curriculum data, learning history data, prompt sentences, model output data, and control parameters used by the processor.

The term “learning unit information” refers to data representing instructional elements defined by an educational plan, including at least topics, subtopics, learning objectives, and relationships between such elements.

The term “learning history information” refers to data representing a learner's past interaction with learning content, including at least completed units, attempted problems, timestamps, scores, and requested explanations.

The term “educational plan” refers to structured information defining an instructional curriculum, including at least a sequence of learning units, prerequisite relationships, and target competency levels.

The term “generative AI model” refers to a machine learning model that generates text or other content in response to an input prompt sentence, based on parameters learned from training data.

The term “prompt sentence” refers to a text string or equivalent structured model input that encodes instructions, conditions, or context to guide output generation by the generative AI model.

The term “learning-story-generation prompt sentence” refers to a prompt sentence that specifies curriculum context, learner status, and desired structure of a learning story, and that is input to the generative AI model to obtain learning story information.

The term “learning story information” refers to data describing a sequence or structure of learning activities, including at least ordered topics, suggested transitions, and associated practice themes for a learner.

The term “answer result information” refers to data representing a learner's responses to problems, including at least given answers, correctness, scores, response times, and problem identifiers.

The term “progress index” refers to a numerical or categorical indicator computed from learning history information and answer result information, representing a learner's advancement level with respect to one or more learning units.

The term “weakness index” refers to a numerical or categorical indicator computed from performance data, representing the degree of a learner's difficulty or deficiency in one or more topics or skills.

The term “problem-set-generation prompt sentence” refers to a prompt sentence that includes problem-set generation conditions, such as topics, difficulty levels, number of problems, and language, and that is input to the generative AI model to obtain problem group information.

The term “problem group information” refers to data representing a set of automatically generated problems, including at least problem texts and associated metadata such as topic tags and difficulty labels.

The term “problem set” refers to an assembled collection of one or more problems selected or constructed from problem group information for presentation to a learner.

The term “learner terminal” refers to an end-user device, such as a computing device with a display and input interface, that presents learning content to a learner and transmits learner inputs, including answers and queries, to the server.

The term “image information” refers to digital image or video data acquired from a capture device, including at least facial region data used for emotion estimation.

The term “audio information” refers to digital audio data acquired from a sound collection device, including at least speech signals or vocal features used for emotion estimation.

The term “capture device” refers to a hardware component, such as an imaging device or a camera, capable of acquiring image information related to a learner.

The term “sound collection device” refers to a hardware component, such as a microphone, capable of acquiring audio information related to a learner.

The term “emotion estimation model” refers to a computational model that receives image information and/or audio information and outputs an estimate of a learner's emotional state, such as confusion, engagement, or stress level.

The term “emotional state” refers to a representation of affective conditions of a learner, expressed as categorical labels or continuous values, and derived from sensor data by the emotion estimation model.

The term “adjustment prompt sentence” refers to a prompt sentence that includes adjustment conditions for modifying learning content characteristics, and that is input to the generative AI model to obtain adjusted learning content information.

The term “adjustment conditions” refers to parameters specifying how learning content should be modified, including at least difficulty, number of questions, amount of explanation, and presentation order.

The term “adjusted learning content information” refers to output data from the generative AI model that reflects changes to learning content according to the adjustment conditions and is used to update learning stories and problem sets.

The term “generation result information” refers to data produced by the generative AI model in response to a prompt sentence, including at least generated text and any associated metadata.

The term “performance indexes” refers to one or more computed indicators derived from evaluation information, including at least correct-answer rate, response time, and explanation-request frequency per field or topic.

The term “weakness area” refers to a topic or skill region determined, based on performance indexes, to exhibit relatively low learner performance or understanding.

The term “weakness-supplement prompt sentence” refers to a prompt sentence that specifies a weakness area, difficulty level, and explanation style, and that is used to cause the generative AI model to generate weakness-supplement problem group information and explanation information.

The term “weakness-supplement problem group information” refers to problem group information that is targeted to a weakness area for the purpose of remediation.

The term “weakness-supplement problem set” refers to a problem set constructed from weakness-supplement problem group information and intended to improve learner performance in an identified weakness area.

The term “explanation style” refers to characteristics of explanatory text, including at least level of detail, tone, structure, and use of examples, specified for generation by the generative AI model.

The term “term information” refers to data identifying a specific word, phrase, or symbol that appears in learning content and is the subject of a requested explanation.

The term “concept information” refers to data identifying an abstract idea, principle, or topic that is the subject of a requested explanation.

The term “learning stage information” refers to data representing an estimated or designated educational level or proficiency stage of a learner, used to control the complexity of generated content.

The term “explanation-generation prompt sentence” refers to a prompt sentence that includes at least an explanation target term, explanation level, explanation language, and explanation format, and that is input to the generative AI model to obtain detailed explanation information.

The term “explanation level” refers to a specification of conceptual depth or complexity, such as beginner, intermediate, or advanced, required for a generated explanation.

The term “explanation language” refers to a natural language in which explanation text is to be generated.

The term “explanation format” refers to structural constraints for an explanation, such as continuous text, bullet points, step-by-step procedure, or question-and-answer style.

The term “detailed explanation information” refers to natural-language text generated by the generative AI model that provides a description, clarification, or example-based explanation of a term or concept at a specified explanation level.

In one or more embodiments, a server executes a computer program that implements the claimed system on a computing platform including at least one processor, a main memory, a non-volatile storage device, and one or more communication interfaces. The server operates under a general-purpose operating system such as a UNIX-type system and executes application software written, for example, in a high-level programming language such as Python. The server communicates over a communication network with a terminal operated by a user. The terminal is implemented by a computing device such as a smartphone, tablet, or personal computer including a display, an input interface, an imaging device, and a sound collection device.

The server stores, in a storage unit such as a relational database management system implemented by a database engine (for example, a lightweight file-based relational database), information representing an educational plan, learning unit information, learning history information, prompt sentences, and generation result information output by a generative AI model. The server stores the educational plan as multiple records, each record including a unit identifier, a topic identifier, a hierarchical level, prerequisite links, and target competencies. The server stores learning history information per user as records containing user identifiers, unit identifiers, problem identifiers, timestamps, answer correctness flags, numerical scores, and explanation-request flags. The server additionally stores emotion-related records including timestamps, session identifiers, and numerical features derived from facial images and audio signals.

The server uses a generative AI model implemented by a trained neural network as a text generation engine. In one embodiment, the generative AI model is a transformer-based language model that has multiple self-attention layers, feed-forward layers, layer normalization components, and learned embedding matrices. The server accesses the generative AI model via an application programming interface exposed by a model execution environment. The server submits, as part of a request, a prompt sentence, a maximum number of output tokens, a sampling temperature, and optional control parameters such as a top-k or top-p value. The model internally represents the prompt sentence as a sequence of token identifiers, computes contextual embeddings using multi-head self-attention, and generates output tokens autoregressively by selecting, at each generation step, a token with probability determined by a softmax layer over the model's vocabulary. The server receives the output tokens, decodes them into a character string, and interprets the result as learning story information, problem group information, or detailed explanation information.

The server also uses an emotion estimation model implemented by a neural network trained for affective state recognition. In one embodiment, the server uses a convolutional neural network to process facial images and a recurrent neural network or transformer to process acoustic features extracted from audio signals. For facial analysis, the server uses a vision library such as a general-purpose image processing library to perform face detection and crop a normalized facial region. The server resizes the cropped image to a standard resolution and normalizes pixel values before passing the image to the convolutional neural network. For voice analysis, the server computes Mel-frequency cepstral coefficients or spectrograms as input features, and passes them to a temporal model. The emotion estimation model outputs one or more real-valued scores for emotional dimensions such as valence, arousal, and dominance, or categorical probabilities for labels such as “confused,” “engaged,” “bored,” and “stressed.” During training, the emotion estimation model uses a loss function such as cross-entropy or mean squared error, and the model parameters are updated by an optimization algorithm such as stochastic gradient descent with momentum or an adaptive gradient method.

The server defines internal data structures and algorithms that combine the outputs of the generative AI model and the emotion estimation model with learning history information in a non-conventional way to improve technical performance. The server maintains, in the storage unit, a prompt log table. Each prompt log record includes fields such as prompt identifier, user identifier, session identifier, prompt sentence text, prompt type (for example, “learning story,” “problem set,” “adjustment,” “explanation”), parameter settings of the generative AI model, and a compact summary of the corresponding generation result. The server additionally stores quality indicators such as a post-hoc relevance score or a later-computed performance gain associated with the generation result.

The server analyzes learning history information using a data analysis library such as a tabular data processing library. The server loads records corresponding to a particular user, groups the records by topic, and computes performance metrics including correct-answer rate, median response time, and explanation-request frequency per topic. The server converts these metrics into a progress index and a weakness index. For example, the server can compute a normalized score per topic by combining correct-answer rate and response time through a weighted formula, and the server can label each topic as “strong,” “moderate,” or “weak” by comparison against predetermined thresholds. In certain embodiments, the server can apply a clustering algorithm such as k-means or a hierarchical clustering method to vectors representing per-topic performance metrics, so as to identify clusters of similar difficulty or weakness patterns. The server then writes the calculated indexes into a profile table, associating each user with topic-specific progress and weakness values.

The server generates a learning-story-generation prompt sentence by embedding structured information from the educational plan and from the user's profile into natural-language instructions. For example, the server reads, from the educational plan table, that a given user is scheduled to study the units “Basic Differentiation” and “Basic Integration” over a particular time frame. The server also reads that the user has a weak index for differentiation and a moderate index for integration. The server then constructs a prompt sentence such as: “Based on a high-school mathematics curriculum including the units ‘Basic Differentiation’ and ‘Basic Integration’, create a step-by-step learning story for a learner who is weak in differentiation and moderate in integration. Organize the story into small sections, each with a short description of the concept and a suggestion for practice problem types. Provide the output in English, without solutions.”

The server configures a generative AI model call with this prompt sentence and with parameters chosen to produce structured, reasonably deterministic text. The server decomposes the returned text into a sequence of learning steps. Each learning step is stored as a record including a step index, a topic identifier, a textual description, and references to future problem set generation.

The server generates a problem-set-generation prompt sentence by combining the progress index, weakness index, and learning story information. For example, if the user's most recent learning story step targets “Basic Differentiation,” and the user is classified as weak in that topic, the server can construct a prompt sentence such as:

“The learner is a high-school student who has just studied the basic rules of differentiation and is still weak in this topic. Generate 10 easy differentiation practice problems focusing on polynomials and simple power rule applications. Provide only the problem statements in English, numbered from 1 to 10, without solutions.”

By encoding this detailed structure, topic specification, difficulty level, and language constraint in the prompt sentence, the server can obtain problem group information from the generative AI model that is precisely tailored to the user's current state. The server parses the generated text by detecting line breaks or numbering patterns, extracts each problem, and stores each as a problem record containing a problem identifier, problem text, topic tag, nominal difficulty, and metadata indicating that the problem was generated by the model using this particular prompt sentence.

The server generates an adjustment prompt sentence by integrating emotional state data with the progress index and weakness index. For example, if the emotion estimation model indicates that the user is bored and the performance in the last few problem sets is high, the server may generate a prompt sentence such as:

“The learner is performing very well on recent problems about quadratic functions and appears bored. Generate 5 more challenging quadratic function problems that introduce new variations, such as vertex form transformations and composition with linear functions. Provide the problems in English and do not include solutions.”

In contrast, if the user appears confused and anxious while solving differentiation problems, the server may generate:

“The learner is confused and anxious about differentiation of polynomials. Generate 6 very simple differentiation examples with coefficients and exponents that are small integers. For each example, provide a step-by-step explanation in plain language after the problem statement. Use English.”

The server sends the adjustment prompt sentence to the generative AI model, receives adjusted learning content information, splits the information into problems and explanations, and updates the learning content delivered to the terminal. Because the server chooses the adjustment conditions (difficulty, amount of explanation, etc.) algorithmically from numeric emotion scores and performance metrics, the system does not merely automate a human tutor's decision, but implements a consistent, programmable decision rule that exploits fine-grained sensor data and model outputs in real time.

The server further improves computational efficiency and technical performance by caching and reusing prompt sentences and generation result information. When the server constructs a new prompt sentence, the server checks whether a similar prompt has previously been used for the same user profile and emotional state. If so, the server can reuse or adapt the previous generation result rather than calling the generative AI model again, thereby reducing network traffic and response latency. The server can also compute, for each prompt type, a performance gain indicator, such as the improvement in correct-answer rate over the subsequent problem set. The server uses this indicator to update the generation conditions for future prompt sentences. For example, if a particular phrasing of a problem-set-generation prompt sentence consistently yields problems that correlate with better learning outcomes, the server can increase the weight of that phrasing in a template and decrease the weight of alternatives. In one embodiment, the server represents prompt templates as parameterized text patterns, and optimizes the parameters using gradient-free optimization or bandit-type selection based on empirical performance data.

The server applies similar principles when generating explanation-generation prompt sentences. When a user selects a term such as “integration” on the terminal and requests an explanation, the terminal transmits term information, the current learning unit, and a summary of recent emotion states. The server uses learning stage information (for example, “upper secondary level”) and the stored weakness index to construct a prompt sentence such as:

“Explain the concept of integration in detail to a high-school learner who has basic knowledge of differentiation but is struggling with understanding the geometric meaning of integration. Use intuitive area-under-the-curve examples and avoid advanced formal notation.”

The server transmits this prompt sentence to the generative AI model, obtains detailed explanation information, and stores the explanation in association with the term. The server may segment the explanation text into paragraphs and send them separately to the terminal for incremental display, enhancing readability. The server also records, in the prompt log, whether the user's performance on subsequent problems referencing integration improves, and updates the explanation-generation prompt template accordingly.

The terminal acquires images of the user's face and audio of the user's voice by controlling the imaging device and the sound collection device. The terminal compresses and encrypts the captured data and transmits it to the server, or, in an alternative embodiment, computes intermediate features such as facial landmark positions, gaze direction vectors, and voice pitch contours on-device, and transmits only those features. Offloading part of the pre-processing to the terminal reduces bandwidth requirements and reduces the load on the server's processing resources. The server then applies the emotion estimation model to the received data to produce emotion labels or continuous scores. Because the emotion estimation model has been trained with large volumes of labeled multimodal data, the model can infer nuanced affective states that would not be feasible to interpret in real time by a human operator monitoring video feeds.

The system improves computer technology by modifying how the server and generative AI model are orchestrated and how data is structured and reused. By logging prompt sentences and associated generation results in a structured prompt log, the server converts otherwise transient text interactions into a machine-readable knowledge base that can be searched, clustered, and optimized. This reduces redundant calls to the generative AI model, lowers response latency, and reduces network traffic, which are concrete technical effects. The server's use of numeric progress and weakness indexes, coupled with numeric emotion scores, allows the server to formulate prompts that directly encode quantitative conditions, resulting in more consistent generation behavior and reducing the need for repeated corrective prompts. The iterative refinement of prompt templates based on performance data moves part of the adaptation logic from manual configuration to a machine-driven, data-driven optimization process.

The system also improves data management by normalizing and structuring learning history information, emotion information, and model output information into tables that share user identifiers, session identifiers, and topic identifiers. This schema enables efficient joins and queries that can be accelerated by indexing, thereby reducing query time and enabling real-time adaptation even with many concurrent users. In addition, the server separates different types of prompt sentences into different logical categories (for example, learning story, problem set, adjustment, explanation), which allows the server to apply distinct optimization and caching strategies per category, further improving computation efficiency. In alternative embodiments, the server can employ different machine learning models for different stages. For example, the server can use a smaller generative AI model for routine explanation generation and a larger, more capable model for generating complex learning stories. The server can also use a dedicated classifier to predict an appropriate difficulty level given a vector of performance metrics and emotion scores. This classifier can be implemented by a feed-forward neural network trained with supervised learning, with a loss function measuring deviation between predicted and empirically optimal difficulty levels as determined from historical data.

In another embodiment, the terminal can perform part of the prompt-sentence construction locally. For example, the terminal can insert device-specific constraints such as display size, available input modalities, or offline/online status into a base prompt template supplied by the server. By enabling the terminal to embed hardware constraints into the prompt sentence, the system ensures that generated content is adapted not only to the learner's cognitive and emotional state but also to the physical capabilities of the device. This integration of hardware characteristics into the generation loop leads to more efficient rendering and fewer layout adjustments on the terminal, reducing computational overhead and improving responsiveness.

The described embodiments are not limited to academic subjects. In a further embodiment, the server applies the same architecture to industrial training scenarios, where the educational plan represents machine operating procedures, and the problems represent simulated tasks. In such deployments, the emotion estimation model can be extended with additional sensors, such as physiological sensors connected to the terminal, to measure heart rate or skin conductance. The server then adapts the training content by adjusting not only conceptual difficulty but also the rate at which new tasks are introduced, thereby modulating cognitive load in a quantifiable way.

Because the server organizes and processes data using defined data structures, algorithms, and model architectures, and because the server uses these components to control the behavior of multiple hardware devices and software modules in a coordinated manner, the system achieves technical improvements over conventional static or manually configured learning platforms. The server reduces average response time by eliminating redundant generative AI calls; the server increases the relevance and accuracy of generated content by encoding fine-grained numeric conditions into prompt sentences; the server reduces memory and bandwidth usage by reusing and adapting previously successful prompts and model outputs; and the server enables more stable and predictable execution of content generation and adaptation routines in large-scale multi-user deployments.

Variations and modifications of the above-described embodiments fall within the scope of the invention. Server, terminal, and user roles, as well as particular hardware and software choices, may be adapted to the requirements of specific deployments, provided that the processor performs the functional combinations of analysis, prompt-sentence generation, generative AI model invocation, emotion-based adjustment, and prompt-and-response association as described.

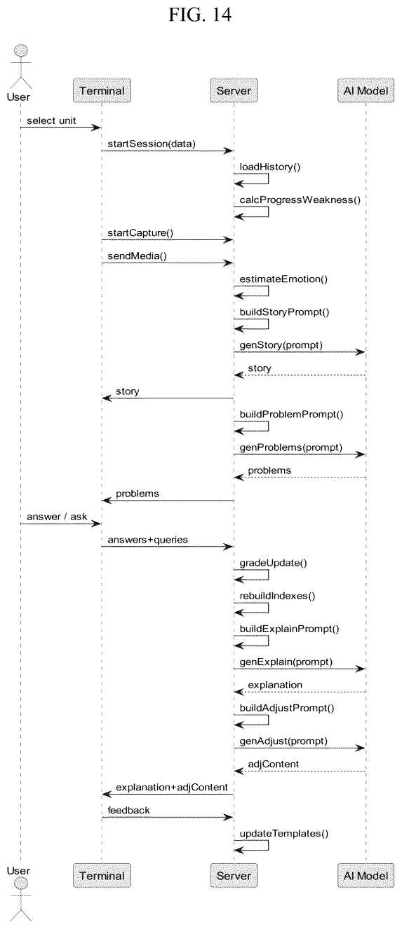

The following describes the processing flow using FIG. 14.

### Step 1:

Server initializes system resources.

Server loads configuration data from the storage unit as input, including model API settings, database connection parameters, curriculum metadata, and prompt templates. Server performs data parsing and validation to convert configuration files into structured in-memory objects, such as dictionaries and configuration classes. Server establishes database connections and network client objects for accessing the generative AI model and emotion estimation services. The output of this step is an initialized runtime environment where the server holds valid handles to the database, external APIs, and in-memory templates for prompt sentences.

### Step 2:

User starts a learning session on the terminal.

User selects a subject, a learning unit, and optionally a target difficulty level on the terminal's user interface. The input is the user's selection (for example, “Mathematics”, “Basic Differentiation”, difficulty “default”). Terminal packages this selection together with a user identifier, device identifier, and timestamp into a structured message. Terminal sends this message to the server as the output of this step.

### Step 3:

Server registers the learning session and retrieves prior learning history.

Server receives the session start message from the terminal as input. Server writes a new session record into the database with fields including session ID, user ID, selected unit ID, and start time. Server then queries the learning history table for records corresponding to the user ID and relevant unit or topic. Server performs aggregation operations, such as grouping by topic and computing counts of attempts, correct answers, and average response times. The output of this step is a session record and a summarized learning history object that includes per-topic performance statistics.

### Step 4:

Server computes progress and weakness indexes.

Server takes the summarized learning history object as input. Server applies numeric data processing, such as computing normalized scores per topic by combining correct-answer rate and median response time through a weighted formula. Server may also compute moving averages over recent sessions to emphasize recent performance. Server labels each topic as “strong”, “moderate”, or “weak” by comparing the normalized scores against predefined thresholds or by running a clustering algorithm over vectors of metrics. The output of this step is a user profile structure containing a progress index and a weakness index per topic, which the server stores in a profile table and retains in memory.

### Step 5:

Terminal starts capturing emotional and behavioral signals.

Terminal receives from the server a command indicating that emotion tracking should be active for the current session. The input is the command containing capture parameters such as capture interval and modality (image and/or audio). Terminal controls the imaging device to capture periodic facial images or short video frames and controls the sound collection device to capture audio segments when the user speaks. Terminal may downsample or compress the captured media and extract basic features such as image resolution and audio level. The output of this step is a stream of media data or feature data tagged with timestamps and session IDs, which the terminal transmits to the server.

### Step 6:

Server estimates the emotional state of the user.

Server receives the media data or feature data from the terminal as input. Server uses a vision library to detect a face region in each image and resizes the face region to a fixed resolution. Server normalizes pixel intensities and passes the processed image to a convolutional neural network of the emotion estimation model. For audio, server computes spectrograms or Mel-frequency cepstral coefficients and passes them to a temporal neural network or transformer. Server performs a forward pass of the model to obtain either categorical probabilities for emotion labels or continuous scores for emotional dimensions. Server then selects the most probable label or retains the continuous scores and stores them in an emotion table with timestamps. The output of this step is a time-series emotional state object associated with the session.

### Step 7:

Server generates a learning-story-generation prompt sentence.

Server uses as input the educational plan data for the unit selected in Step 2 and the user profile containing progress and weakness indexes from Step 4. Server reads from the curriculum table which topics and subtopics belong to the selected unit and how they are ordered. Server applies rule-based logic to decide which topics should be emphasized or repeated according to the weakness indexes. Server instantiates a text template for a learning story prompt by inserting topic names, user level, and emphasis instructions. For example, server may generate the following prompt sentence as output of this step:

“Based on a high-school mathematics curriculum including the units ‘Basic Differentiation’ and ‘Basic Integration’, create a step-by-step learning story for a learner who is weak in differentiation and moderate in integration. Organize the story into small sections, each with a short description of the concept and a suggestion for practice problem types. Provide the output in English, without solutions.”

Server logs this prompt sentence into the prompt log table with a new prompt identifier.

### Step 8:

Server calls the generative AI model to generate learning story information.

Server takes the learning-story-generation prompt sentence and model configuration parameters as input. Server constructs an API request including the prompt sentence, a maximum token length, a sampling temperature, and other decoding parameters. Server submits the request to the generative AI model endpoint and waits for a response. Server receives a sequence of output tokens, decodes them into text, and parses the text into structured sections representing learning steps (for example, by splitting on headings or numbered items). The output of this step is a learning story object containing an ordered list of learning steps and associated topics, which the server stores in the database and marks as active for the current session.

### Step 9:

Server generates a problem-set-generation prompt sentence.

Server uses the current learning story object, the user profile, and possibly the most recent emotional state as input. Server identifies the current or next learning step and determines the target topic (for example, “Basic Differentiation”) and preferred difficulty (for example, “easy” or “challenging”) based on the weakness index and emotional state. Server selects or constructs a text template for a problem set. Server fills the template with values such as topic names, number of problems, difficulty description, and language. For example, server may output the following prompt sentence:

“The learner is a high-school student who has just studied the basic rules of differentiation and is still weak in this topic. Generate 10 easy differentiation practice problems focusing on polynomials and simple power rule applications. Provide only the problem statements in English, numbered from 1 to 10, without solutions.”

Server records this problem-set-generation prompt sentence in the prompt log and associates it with the session and user.

### Step 10:

Server calls the generative AI model to generate problem group information.

Server takes the problem-set-generation prompt sentence and model parameters as input. Server sends an API request to the generative AI model and receives generated text that should contain multiple problem statements. Server applies text processing, such as splitting the text on line breaks or numeric prefixes, to isolate individual problems. Server performs basic validation, such as filtering out empty lines and checking for duplicate problems. The output of this step is problem group information containing a list of problem records with problem texts, which the server writes into a problem table with fields such as problem ID, topic tag, and difficulty label.

### Step 11:

Server constructs and sends a problem set to the terminal.

Server uses the problem group information generated in Step 10 as input. Server selects a subset of problems if necessary and orders them according to the learning story or adjustment conditions (for example, from easiest to hardest). Server formats the problem texts, adds metadata such as expected answer type and target time per problem, and packages them into a response message. Server transmits this message to the terminal as the output of this step.

### Step 12:

Terminal displays the problem set and collects answers.

Terminal receives the problem set message from the server as input. Terminal parses the message, renders each problem on the display, and creates appropriate input widgets (for example, text fields or multiple-choice buttons). User reads each problem and enters an answer using the terminal's input interface. Terminal measures the time between the display of a problem and the submission of an answer and records whether the user requested hints or explanations. The output of this step is answer result information containing, for each problem, the problem ID, user answer, response time, and any flags for hint or explanation requests.

### Step 13:

Terminal transmits answer result information and explanation requests to the server.

Terminal packages the answer result information and any explicit explanation requests (for example, selected terms or user-typed questions) into a structured message as input to the server. Terminal tags each explanation request with related problem IDs and the current learning unit. Terminal sends this message to the server. The output of this step is the delivery of evaluation data and explanation targets to the server.

### Step 14:

Server grades answers and updates learning history.

Server receives the answer result information from the terminal as input. Server queries the problem table for correct answers or evaluation rules corresponding to each problem ID. For problems with exact answers, server compares user answers to correct values, applying numeric tolerance rules if necessary. For open-ended answers, server may generate an additional prompt sentence asking the generative AI model to evaluate the answer, such as:

“Evaluate the following student answer to this differentiation question and assign a score from 0 to 1, and give a short explanation.”

Server combines rule-based and model-based evaluations to compute a correctness flag and a numeric score for each problem. Server then writes new learning history records with fields for correctness, score, response time, and flags for explanation requests. The output of this step is an updated learning history dataset reflecting the current problem set.

### Step 15:

Server recomputes progress and weakness indexes.

Server takes the updated learning history dataset as input. Server performs aggregation over an extended time window that includes the latest answers. Server recomputes correct-answer rates, median response times, and explanation-request frequencies per topic. Server plugs these metrics into the same formulas or clustering algorithms used previously to update the progress index and weakness index. Server overwrites or appends the updated profile for the user in the profile table. The output of this step is a refreshed user profile that reflects the most recent performance.

### Step 16:

Server generates explanation-generation prompt sentences for requested terms or concepts. Server processes the explanation requests received in Step 13 as input. Server extracts term information or concept information (for example, “integration” or “chain rule”), and retrieves the user's learning stage information and recent emotional state. Server applies template logic to generate an explanation-generation prompt sentence that specifies the term, explanation level, language, and format. For example, server may output:
“Explain the concept of integration in detail to a high-school learner who has basic knowledge of differentiation but is struggling with understanding the geometric meaning of integration. Use intuitive area-under-the-curve examples and avoid advanced formal notation.”
or
“Explain the chain rule in differentiation in simple, step-by-step language suitable for a beginner.”

Server logs each explanation-generation prompt sentence in the prompt log with associated metadata.

### Step 17:

Server calls the generative AI model to generate detailed explanation information. Server uses the explanation-generation prompt sentence as input to the generative AI model. Server sends an API request and receives generated text as the model output. Server performs light post-processing such as trimming whitespace and splitting long paragraphs into shorter segments for display. Server stores the explanation text in an explanation table associated with the term or concept, user ID, and session ID. The output of this step is detailed explanation information ready to be presented to the user.

### Step 18:

Server sends explanations and adjusted content to the terminal.

Server takes as input the detailed explanation information from Step 17, the updated user profile from Step 15, and the emotional state from Step 6. Server may also generate an adjustment prompt sentence that takes into account the current weakness and emotional state to create a remedial or advanced problem set. For example, server may generate:

“The learner is confused and anxious about differentiation of polynomials. Generate 6 very simple differentiation examples with coefficients and exponents that are small integers. For each example, provide a step-by-step explanation in plain language after the problem statement. Use English.”

Server calls the generative AI model with this adjustment prompt sentence and obtains adjusted learning content information. Server then packages the explanations and, if present, the remedial or advanced problem set into a response message and transmits it to the terminal. The output of this step is a combined payload of explanations and adapted learning content.

### Step 19:

Terminal presents explanations and adapted content and collects further responses. Terminal receives from the server the explanations and any adjusted problem sets as input. Terminal displays explanations associated with the relevant terms or problems, possibly in a side panel or overlay, and renders the new problems according to the specified difficulty and format. User reads the explanations, solves the remedial or advanced problems, and provides further answers or follow-up questions. Terminal records these new interactions, including any change in behavior (for example, fewer explanation requests on the explained concept), and prepares the next batch of answer result information. The output of this step is another cycle of user responses, which can be sent back to the server to continue the adaptive loop.

### Step 20:

Server updates prompt templates and optimization data.

Server considers as input the updated learning history, the recorded emotional states, and the prompt log entries for the session. Server analyzes, for each prompt sentence used, whether the corresponding generation result improved performance metrics, such as correct-answer rate on subsequent problems or reduction in explanation-request frequency. Server assigns a performance score to each prompt template variant and adjusts template parameters, for example by increasing the selection probability of high-performing templates and decreasing that of low-performing ones. Server updates the stored prompt templates in the storage unit. The output of this step is an optimized set of prompt templates that will influence future prompt sentence generation, thereby improving the effectiveness and efficiency of subsequent sessions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

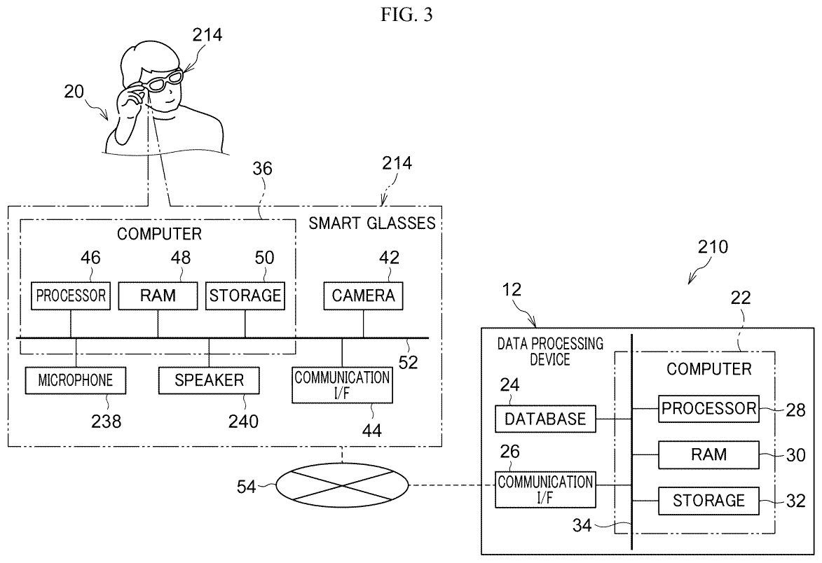

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

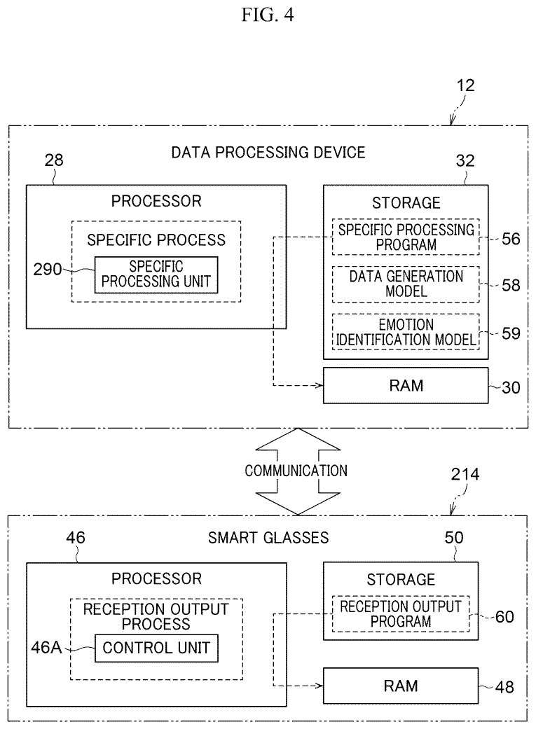

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

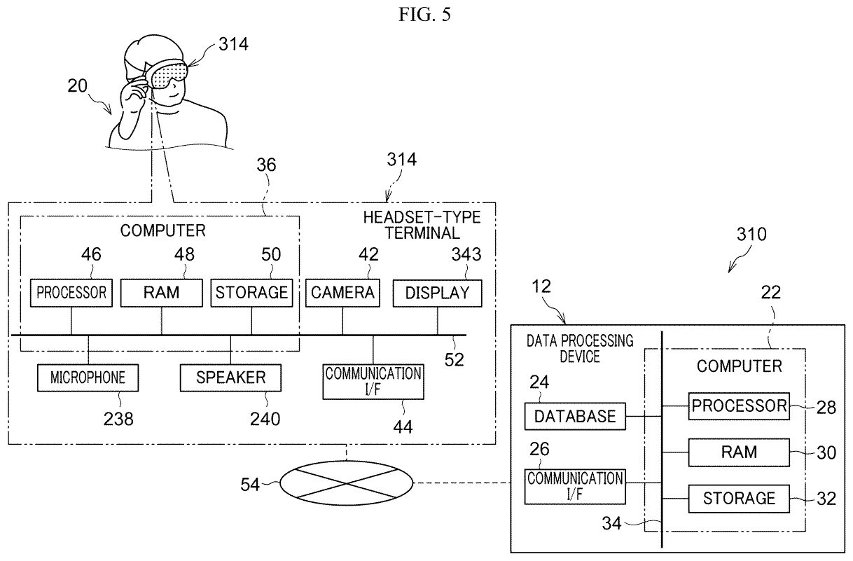

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

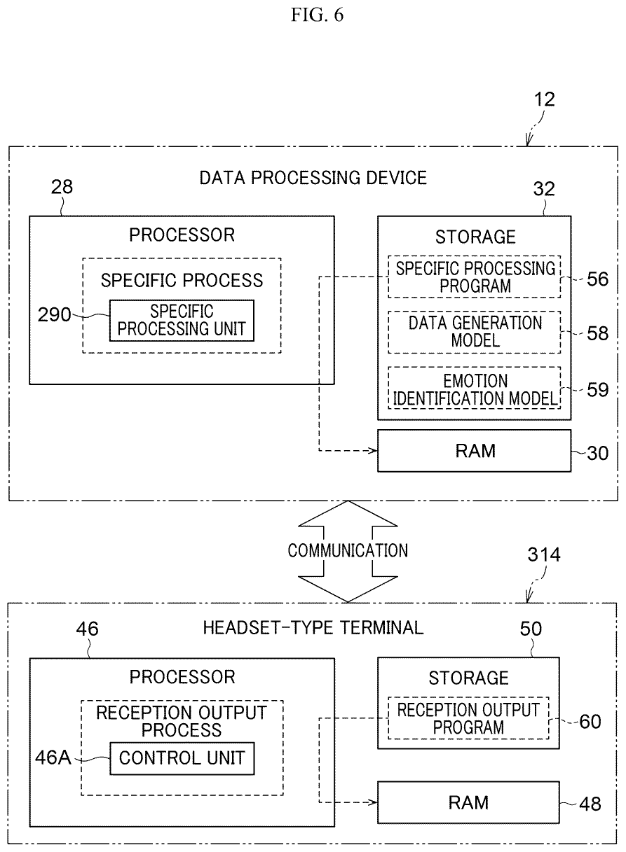

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

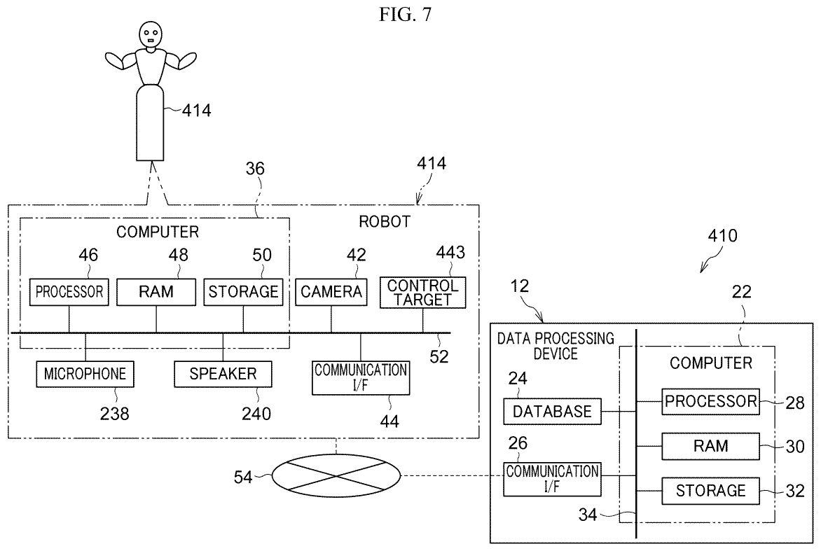

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

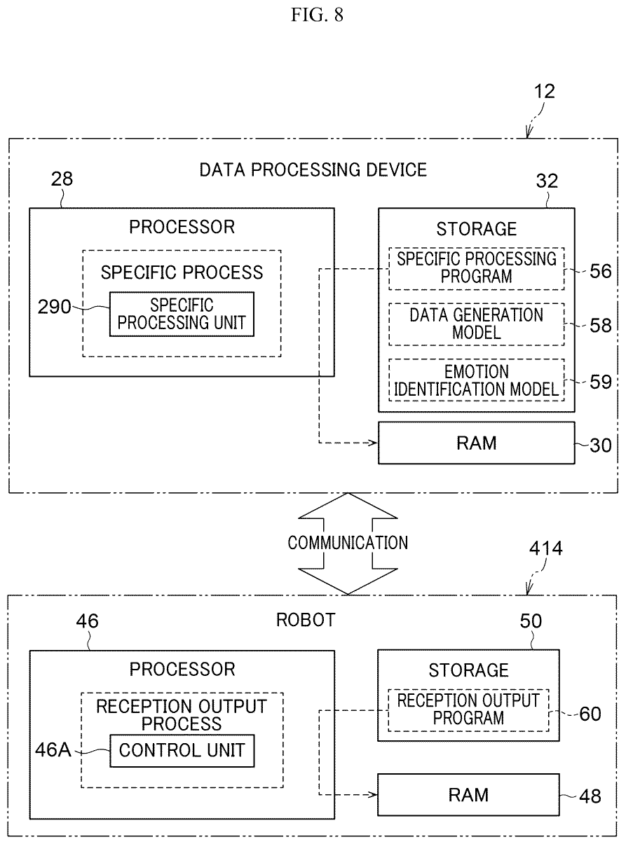

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

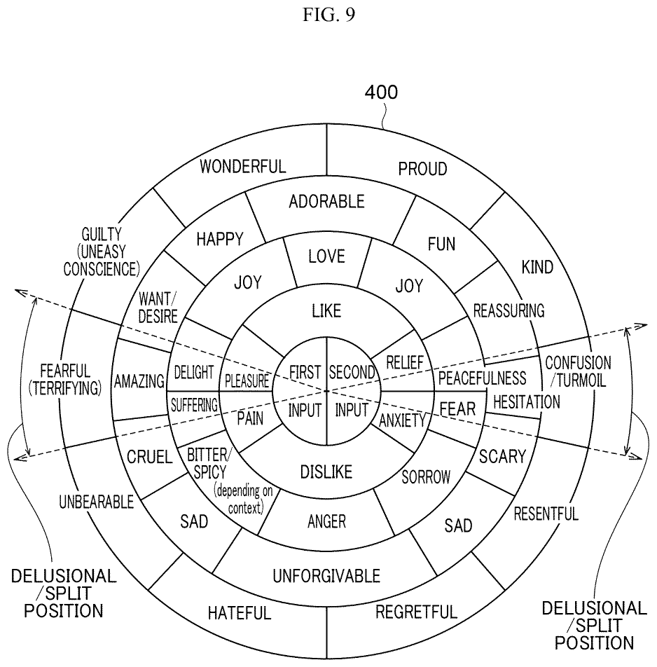

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

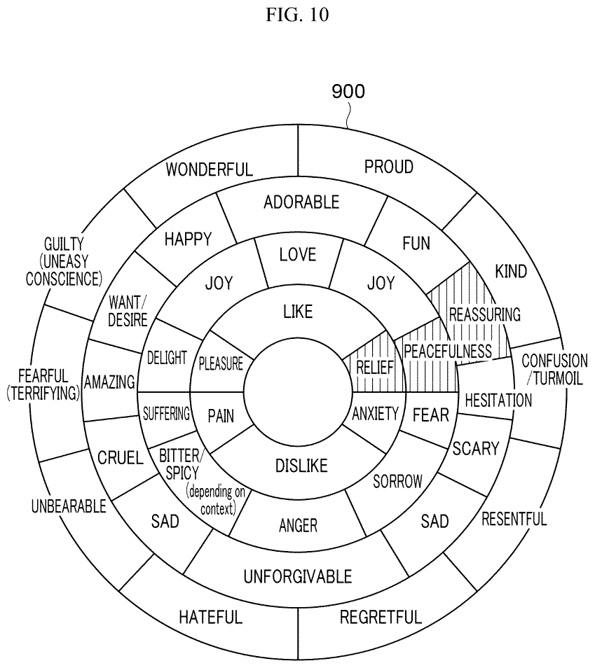

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire educational plan information, identify a learning target field and a learning objective based on the educational plan information, generate a prompt sentence including the learning target field and the learning objective, and instruct a generative AI model to generate learning story-type content by using the prompt sentence; and
receive, from a learning information processing terminal, a request to provide the learning story-type content to a learner, transmit the learning story-type content acquired from the generative AI model to the learning information processing terminal, and store exercise task information and related activity information based on the learning story-type content as structured data; and
accumulate learning progress data including operation history, answer content, and learning time information of the learner acquired from the learning information processing terminal, calculate a learning achievement index based on the learning progress data, generate an evaluation prompt sentence including the learning achievement index and an identified weak field, and instruct the generative AI model to generate feedback explanation text and additional exercise tasks by using the evaluation prompt sentence; and
transmit the feedback explanation text and the additional exercise tasks acquired from the generative AI model to the learning information processing terminal, and generate adaptive learning control information for gradually changing a configuration of the learning story-type content and the exercise tasks in accordance with the learning achievement index.

### Supplementary 2

The system according to supplementary 1,
wherein the processor is configured to perform scoring processing on an answer history included in the learning progress data, calculate an incorrect answer tendency and a correctness rate for each concept, identify a weak region based on the incorrect answer tendency and the correctness rate, generate a problem-generation prompt sentence including a supplementary explanation request corresponding to the weak region and target difficulty information, and instruct the generative AI model to automatically create a problem set for reinforcing the weak region by using the problem-generation prompt sentence.

### Supplementary 3

The system according to supplementary 1,
wherein the processor is configured to extract a difficult-to-understand term and a difficult-to-understand concept based on term selection operation information and explanation request operation information acquired from the learning information processing terminal, generate an explanation-generation prompt sentence including the difficult-to-understand term, the difficult-to-understand concept, and a learning achievement index of the learner relating to the difficult-to-understand term or the difficult-to-understand concept, instruct the generative AI model to generate detailed explanation content by natural language processing using the explanation-generation prompt sentence, and provide the detailed explanation content to the learning information processing terminal.

### Application Example 1

### Supplementary 1

A system comprising a processor,
wherein the processor is configured to
acquire educational information from an information storage unit, and generate a template of a learning story including learning units and learning order on the basis of the educational information, and distribute the learning story to a terminal device,
accumulate progress data including answer contents, answer time, and operation history acquired from the terminal device, and calculate a comprehension index and weak concepts of a learner on the basis of the progress data,
generate a prompt sentence that instructs generation of problem set data by selecting learning items and difficulty levels to be presented on the basis of the comprehension index and the weak concepts, and automatically configure the problem set data as a set of problem data including problem text, option information, and answer information,
generate a meta prompt to be input to a generative AI model on the basis of the educational information and the progress data, and generate, by performing post-processing on a text generation result output from the generative AI model, a prompt sentence that instructs or guides a next learning action in accordance with a current learning state of the learner, and provide the prompt sentence to the terminal device,
estimate an emotional state of the learner on the basis of biological information, behavior information, or facial information received from the terminal device, and generate a prompt sentence that instructs dynamic change of order, amount, or difficulty of the learning story and the problem set data in accordance with the emotional state and the progress data, generate, by natural language processing using the generative AI model, a detailed explanation text of a term or a concept on the basis of term information and learning context information received from the terminal device, and provide the detailed explanation text to the terminal device, and
acquire, on a continuous basis, reactions of the learner to presentation of the learning story, the problem set data, and the prompt sentences, and update configuration of the learning story and generation conditions of the prompt sentences in accordance with the reactions, thereby sequentially optimizing a learning path for the learner.

### Supplementary 2

The system according to supplementary 1,
wherein the processor is configured to
calculate, on the basis of correctness information and answer time included in the progress data for each problem, an achievement index for each concept, identify as a weak concept a concept whose achievement index is lower than a predetermined threshold, and generate a prompt sentence that instructs automatic generation of new problem set data including, with priority, problem data associated with the weak concept or problem data generated by the generative AI model.

### Supplementary 3

The system according to supplementary 1,
wherein the processor is configured to
input to the generative AI model a meta prompt including a current learning unit, a recent correct answer rate, answer time, and the weak concepts of the learner, and format a text generation result output from the generative AI model into a single prompt sentence, thereby generating an individualized prompt sentence including an instruction that encourages at least one of difficulty change, insertion of review, or viewing of an additional explanation, and cause the terminal device to present the individualized prompt sentence.

### Example 2

### Supplementary 1

A system comprising a processor and a memory,
wherein the memory stores instructions that, when executed by the processor, cause the processor to
store learner-related history information and evaluation information as learning progress information in a storage unit,
analyze the learning progress information including learning history, evaluation results, learning time, and achievement level for each learning domain, and determine a weak domain and a priority learning domain for a learner,
generate, on the basis of the determined learning domain, a number of problems, a difficulty level, a problem type, and an output distribution, a prompt sentence described in a natural language as generation instruction information for a generative AI model,
transmit, via a communication network, the prompt sentence to the generative AI model disposed externally or internally to the system, and receive, from the generative AI model, a group of problem texts generated in response to the prompt sentence,
parse and format the group of problem texts in accordance with a predefined rule, assign problem identification information, domain information, and difficulty information to each problem text, structure the problem texts as problem set data, and store the structured problem set data in association with the learning progress information in the storage unit, convert the problem set data into a transmission format corresponding to a user terminal, transmit the converted problem set data to the user terminal, and receive answer information and learning behavior information from the user terminal, and
execute grading processing and statistical processing on the basis of the answer information, calculate, for each learning domain, a correctness rate, an answer time, and an error tendency, and update the learning progress information so that subsequent prompt sentences are generated iteratively in accordance with the updated learning progress information.

### Supplementary 2

The system according to supplementary 1,
wherein the processor is configured to
generate, on the basis of the weak domain determined from the learning progress information and on the basis of problem set generation history, a prompt sentence that specifies a problem type, a question format, and explanation generation conditions for reinforcing the weak domain,
transmit the prompt sentence to the generative AI model, receive, from the generative AI model, a group of problem texts for weak-domain reinforcement, and
automatically construct, from the group of problem texts for weak-domain reinforcement, a new problem set as the problem set data.

### Supplementary 3

The system according to supplementary 1,
wherein the processor is configured to
identify, from the answer information and the learning behavior information, a term or concept on which incorrect answers are concentrated,
generate a prompt sentence that instructs the generative AI model to generate an explanatory text including a meaning explanation, an intuitive analogy, an example, and stepwise explanation steps for the identified term or concept,
transmit the prompt sentence to the generative AI model, receive, from the generative AI model, a detailed explanatory text generated by a natural language processing technique, and provide the detailed explanatory text as explanation information to the learner via the user terminal.

### Application Example 2

### Supplementary 1

A system comprising a processor,
wherein the processor is configured to
acquire learning unit information and learning history information, which are based on an educational plan of an educational institution, from a storage unit, generate a learning-story-generation prompt sentence to be input to a generative AI model as a machine learning model, and instruct the generative AI model to generate learning story information by inputting the learning-story-generation prompt sentence to the generative AI model, analyze learning history information and answer result information of a learner to calculate a progress index and a weakness index for the learner, generate a problem-set-generation prompt sentence including problem-set generation conditions based on the progress index and the weakness index, instruct the generative AI model to generate problem group information by inputting the problem-set-generation prompt sentence to the generative AI model, and construct the generated problem group information as a problem set and provide the problem set to a learner terminal,
obtain image information and audio information from an imaging device and a sound collection device, calculate an emotional state of the learner over time by using an emotion estimation model, generate an adjustment prompt sentence including adjustment conditions for changing at least one of difficulty, number of questions, amount of explanation, and presentation order of the learning story information and the problem group information based on the emotional state, the progress index, and the weakness index, instruct the generative AI model to generate adjusted learning content information by inputting the adjustment prompt sentence to the generative AI model, and instruct dynamic updating of contents of the learning story and the problem set based on the adjusted learning content information, and associate the learning-story-generation prompt sentence, the problem-set-generation prompt sentence, and the adjustment prompt sentence with generation result information output from the generative AI model corresponding to each of the prompt sentences, store the association in the storage unit, and update generation conditions of subsequent prompt sentences for later sessions based on the association.

### Supplementary 2

The system according to supplementary 1,
wherein the processor is configured to
compare answer information for problems, which is acquired from the learner terminal, with correct answer information to generate evaluation information for each problem, calculate performance indexes including, for each field, at least a correct-answer rate, a response time, and an explanation-request frequency based on the evaluation information, identify a weakness area based on the performance indexes, generate a weakness-supplement prompt sentence including at least a difficulty level and an explanation style corresponding to the identified weakness area and an emotional state of the learner, instruct the generative AI model to generate weakness-supplement problem group information and explanation information by inputting the weakness-supplement prompt sentence to the generative AI model, and instruct provision of the weakness-supplement problem group information and the explanation information to the learner terminal as a weakness-supplement problem set.

### Supplementary 3

The system according to supplementary 1,
wherein the processor is configured to
generate an explanation-generation prompt sentence including explanation target term information, an explanation level, an explanation language, and an explanation format based on at least one of term information and concept information acquired from the learner terminal and based on learning stage information and emotional state information of the learner, instruct the generative AI model to generate detailed explanation information in a natural language by inputting the explanation-generation prompt sentence to the generative AI model, instruct presentation of the generated detailed explanation information to the learner terminal in association with the term information or the concept information, and update generation conditions of the explanation-generation prompt sentence based on evaluation information and emotional state information of the learner after the detailed explanation information is presented.

What is claimed is:

1. A system comprising:
circuitry configured to:
receive, via a communication interface coupled to a packet-switched network, educational plan information from a terminal device, identify a target subject field and a learning objective based on the educational plan information, generate a prompt sentence comprising the target subject field and the learning objective, and execute inference processing using a generative neural network model with the prompt sentence as input to generate structured content data;
receive, from the terminal device via the communication interface, a request to provide the structured content data, transmit the structured content data to the terminal device, and store exercise task information and activity information derived from the structured content data as structured data in a storage device;
accumulate learning progress data comprising at least operation history, answer content, and learning time information from the terminal device, calculate a learning achievement index based on the learning progress data, generate an evaluation prompt sentence comprising the learning achievement index and an identified weak field, and execute inference processing using the generative neural network model with the evaluation prompt sentence as input to generate feedback explanation text and additional exercise task data; and
transmit the feedback explanation text and the additional exercise task data to the terminal device via the communication interface, and generate adaptive control information for adjusting a configuration of the structured content data and the exercise task information in accordance with the learning achievement index.

2. The system according to claim 1, wherein the circuitry is configured to identify the target subject field and the learning objective by parsing the educational plan information to extract at least one of a subject area identifier, a learner level parameter, and an objective description field.

3. The system according to claim 2, wherein the circuitry is configured to generate the prompt sentence by embedding the target subject field, the learning objective, and format instructions into a natural language template for input to the generative neural network model.

4. The system according to claim 3, wherein the circuitry is configured to structure the content data generated by the generative neural network model into a hierarchical format comprising a narrative section, an example section, and an exercise section.

5. The system according to claim 4, wherein the circuitry is configured to store the exercise task information and the activity information in the storage device as structured records associated with a learner identifier and a target subject field identifier.

6. The system according to claim 1, wherein the circuitry is configured to calculate the learning achievement index by applying a scoring function to the answer content and the learning time information to generate a numerical achievement score.

7. The system according to claim 6, wherein the circuitry is configured to identify the weak field by comparing achievement scores across subject area sub-fields and selecting sub-fields having achievement scores below a weakness threshold value.

8. The system according to claim 7, wherein the circuitry is configured to generate the evaluation prompt sentence by embedding the learning achievement index, the identified weak field, and prior exercise task information as structured fields for the generative neural network model.

9. The system according to claim 8, wherein the circuitry is configured to generate the adaptive control information by computing a configuration adjustment parameter based on the learning achievement index and applying the adjustment parameter to modify at least one of a difficulty level and a content volume of subsequently generated structured content data.

10. The system according to claim 1, wherein the circuitry is configured to detect an affective state of the user from the operation history data using an affective recognition model, and include the detected affective state as an adjustment condition in the evaluation prompt sentence.

11. The system according to claim 10, wherein the circuitry is configured to, when the detected affective state indicates reduced engagement, reduce the content volume parameter and increase the example density in subsequently generated structured content data.

12. The system according to claim 1, wherein the circuitry is configured to generate, in response to a term definition request received from the terminal device, a definition prompt sentence and execute inference processing using the generative neural network model to generate a context-aware term explanation.

13. The system according to claim 12, wherein the circuitry is configured to include, in the definition prompt sentence, the target subject field and relevant prior content from the structured data to cause the generative neural network model to generate a context-specific explanation.

14. The system according to claim 1, wherein the circuitry is configured to store the prompt sentence, the structured content data, and the feedback explanation text as session log information in the storage device, and update prompt sentence generation conditions based on the stored session log information.

15. The system according to claim 14, wherein the circuitry is configured to retrieve, from the stored session log information, prior structured content data associated with similar target subject field and learning achievement index values using a similarity search, and incorporate the retrieved data as context in a subsequent prompt sentence.

16. The system according to claim 1, wherein the circuitry is configured to generate the additional exercise task data at a difficulty level calibrated to the learning achievement index, and transmit the additional exercise task data as a sequential learning path to the terminal device.

17. The system according to claim 16, wherein the circuitry is configured to update the difficulty level of the additional exercise task data based on answer correctness rates derived from accumulated learning progress data.

18. A system comprising:
circuitry configured to:
receive, via a communication interface coupled to a packet-switched network, educational plan information identifying a target subject field and a learning objective, generate a prompt sentence embedding the target subject field and the learning objective, and execute inference processing using a generative neural network model to generate structured content data comprising a narrative section, an example section, and an exercise section;
accumulate learning progress data comprising operation history, answer content, and learning time information, calculate a learning achievement index from the learning progress data, identify a weak field by comparing achievement scores across sub-fields, and generate an evaluation prompt sentence embedding the learning achievement index and the identified weak field;
execute inference processing using the generative neural network model with the evaluation prompt sentence as input to generate feedback explanation text and additional exercise task data calibrated to the learning achievement index; and
transmit the feedback explanation text and the additional exercise task data to the terminal device via the communication interface, and generate adaptive control information adjusting a configuration of subsequent structured content data and exercise task data in accordance with the learning achievement index.

19. The system according to claim 18, wherein the circuitry is configured to detect an affective state of the user from the operation history data using an affective recognition model, and include the detected affective state as an adjustment condition in the evaluation prompt sentence to cause the generative neural network model to adapt content volume and difficulty level.

20. A method comprising:
receiving, via a communication interface coupled to a packet-switched network, educational plan information from a terminal device, identifying a target subject field and a learning objective based on the educational plan information, generating a prompt sentence comprising the target subject field and the learning objective, and executing inference processing using a generative neural network model with the prompt sentence as input to generate structured content data;
receiving, from the terminal device via the communication interface, a request to provide the structured content data, transmitting the structured content data to the terminal device, and storing exercise task information and activity information derived from the structured content data as structured data in a storage device;
accumulating learning progress data comprising at least operation history, answer content, and learning time information from the terminal device, calculating a learning achievement index based on the learning progress data, generating an evaluation prompt sentence comprising the learning achievement index and an identified weak field, and executing inference processing using the generative neural network model with the evaluation prompt sentence as input to generate feedback explanation text and additional exercise task data; and
transmitting the feedback explanation text and the additional exercise task data to the terminal device via the communication interface, and generating adaptive control information for adjusting a configuration of the structured content data and the exercise task information in accordance with the learning achievement index.
